(19) United States
(12) Patent Application Publication
(10) Pub. No.: US 2026/0346141 A1
(43) Pub. Date: Nov. 5, 2026

(54) DISPLAYING VIRTUAL PIECE BATTLE FORMATION

(71) Applicant: Tencent Technology (Shenzhen) Company Limited, Shenzhen (CN)

(72) Inventor: Ye KUANG, Shenzhen (CN)

(73) Assignee: Tencent Technology (Shenzhen) Company Limited, Shenzhen (CN)

(21) Appl. No.: 19/708,860

(22) Filed: Jun. 15, 2026

Related U.S. Application Data
(63) Continuation of application No. PCT/CN2025/074814, filed on Jan. 24, 2025.

(30) Foreign Application Priority Data
Feb. 8, 2024 (CN) 202410178054.0

(51) Int. Cl. A63F 13/533; A63F 13/537; A63F 13/56; A63F 13/58; A63F 13/795; A63F 13/822

(52) U.S. Cl. CPC A63F 13/533; A63F 13/537; A63F 13/795; A63F 13/822; A63F 13/56; A63F 13/58

(57) ABSTRACT

Aspects of the present disclosure provide a method for displaying a virtual piece battle formation. In the method, first virtual pieces are displayed in a first board area of a first virtual match interface of a first user. The first virtual pieces are to participate in a virtual battle with second virtual pieces displayed in a second board area of a second virtual match interface of a second user. In the first board area of the first virtual match interface, a first battle formation of the second virtual pieces is displayed. The first battle formation indicates a second battle formation of the second virtual pieces in the second board area of the second virtual match interface of the second user. In the first board area of the first virtual match interface, the first battle formation is updated in response to a change in the second battle formation.

### RELATED APPLICATIONS

The present application is a continuation of International Application No. PCT/CN2025/074814, filed on Jan. 24, 2025, which claims priority to Chinese Patent Application No. 202410178054.0, filed on Feb. 8, 2024. The entire disclosures of the prior applications are hereby incorporated by reference.

### FIELD OF THE TECHNOLOGY

Aspects of this disclosure relate to the field of computer technologies, including a method, an apparatus, a device, a medium, and a product for displaying a virtual piece battle formation.

### BACKGROUND

Auto Chess is a genre of tactical strategy video games that incorporates elements similar to chess. The gameplay of Auto Chess is as follows: player accounts are matched for a match. Before the match begins, players place virtual pieces purchased from a shop onto a board area for battles. Once the match is started, the virtual pieces from different accounts battle automatically without requiring further player input. Therefore, a reasonable battle formation of virtual pieces is crucial for a player to achieve victory.

### SUMMARY

Aspects of this disclosure include a method, an apparatus, a device, a medium, and a product for displaying a virtual piece battle formation. Examples of technical solutions are as follows.

According to an aspect, a method for displaying a virtual piece battle formation is provided. In the method, first virtual pieces are displayed in a first board area of a first virtual match interface of a first user. The first virtual pieces are to participate in a virtual battle with second virtual pieces displayed in a second board area of a second virtual match interface of a second user. In the first board area of the first virtual match interface, a first battle formation of the second virtual pieces is displayed. The first battle formation indicates a second battle formation of the second virtual pieces in the second board area of the second virtual match interface of the second user. In the first board area of the first virtual match interface, the first battle formation is updated in response to a change in the second battle formation.

According to an aspect, an apparatus for displaying a virtual piece battle formation is provided. The apparatus includes processing circuitry configured to display first virtual pieces in a first board area of a first virtual match interface of a first user. The first virtual pieces are to participate in a virtual battle with second virtual pieces displayed in a second board area of a second virtual match interface of a second user. The processing circuitry is configured to display, in the first board area of the first virtual match interface, a first battle formation of the second virtual pieces. The first battle formation indicates a second battle formation of the second virtual pieces in the second board area of the second virtual match interface of the second user. The processing circuitry is configured to update, in the first board area of the first virtual match interface, the first battle formation in response to a change in the second battle formation.

According to an aspect, a non-transitory computer-readable storage medium is provided. The non-transitory computer-readable storage medium stores instructions, which when executed by a processor, cause the processor to implement a method for displaying a virtual piece battle formation. In the method, first virtual pieces are displayed in a first board area of a first virtual match interface of a first user. The first virtual pieces are to participate in a virtual battle with second virtual pieces displayed in a second board area of a second virtual match interface of a second user. In the first board area of the first virtual match interface, a first battle formation of the second virtual pieces is displayed. The first battle formation indicates a second battle formation of the second virtual pieces in the second board area of the second virtual match interface of the second user. In the first board area of the first virtual match interface, the first battle formation is updated in response to a change in the second battle formation.

According to an aspect, a method for displaying a virtual piece battle formation is provided, the method including: displaying a virtual match interface of a first account in a turn-based board game, the virtual match interface including a first board area, the first board area including virtual pieces deployed by the first account, and the virtual pieces in the first board area being configured for participating in a turn-based virtual battle based on a battle formation; displaying a virtual piece battle formation of a second account in the first board area in response to a formation display operation on the second account, the virtual piece battle formation of the second account being a battle formation of virtual pieces deployed by the second account in a second board area, and the second board area being an area displayed in a virtual match interface of the second account; and updating the virtual piece battle formation of the second account in the first board area in response to a change in a virtual piece battle formation of the second account in the second board area.

According to another aspect, an apparatus for displaying a virtual piece battle formation is provided, the apparatus including: a match interface display module, configured to display a virtual match interface of a first account in a turn-based board game, the virtual match interface including a first board area, the first board area including virtual pieces deployed by the first account, and the virtual pieces in the first board area being configured for participating in a turn-based virtual battle based on a battle formation; a formation display module, configured to display a virtual piece battle formation of a second account in the first board area in response to a formation display operation on the second account, the virtual piece battle formation of the second account being a battle formation of virtual pieces deployed by the second account in a second board area, and the second board area being an area displayed in a virtual match interface of the second account; and an update and display module, configured to update the virtual piece battle formation of the second account in the first board area in response to a change in a virtual piece battle formation of the second account in the second board area.

According to another aspect, a computer device is provided, the computer device including a processor (an example of processing circuitry) and a memory, the memory having at least one instruction, at least one program, a code set, or an instruction set stored therein, and the at least one instruction, the at least one program, the code set, or the instruction set being loaded and executed by the processor to implement the method for displaying a virtual piece battle formation in any of the foregoing aspects of this disclosure.

According to another aspect, a computer-readable storage medium (e.g., non-transitory computer-readable storage medium) is provided, the storage medium having at least one instruction, at least one program, a code set, or an instruction set stored therein, and the at least one instruction, the at least one program, the code set, or the instruction set being loaded and executed by a processor to implement the method for displaying a virtual piece battle formation in any of the foregoing aspects of this disclosure.

According to another aspect, a computer program product or a computer program is provided, the computer program product or the computer program including computer instructions, and the computer instructions being stored in a computer-readable storage medium. A processor of a computer device reads the computer instructions from the computer-readable storage medium, and the processor executes the computer instructions, to enable the computer device to perform the method for displaying a virtual piece battle formation in any of the foregoing aspects.

Beneficial effects of the technical solutions provided in the aspects of this disclosure include at least: The virtual match interface of the first account includes the first board area of the first account, and the first board area includes the virtual pieces deployed by the first account. In response to the formation display operation on the second account, the virtual piece battle formation of the second account can be intuitively displayed in the first board area of the first account. Therefore, virtual piece battle formations of different accounts can be directly observed without repeatedly switching perspectives, thereby simplifying operations of viewing the virtual piece battle formations, and improving human-computer interaction efficiency. In addition, because game screens do not need to be repeatedly loaded, calculation resources are saved, freezing of game screens is reduced, and load on a running process of a computer device is reduced. In addition, compared with the related technology in which a player switches to another player's perspective to obtain piece formation information from a mirrored perspective and then switches back to the player's own perspective, because the method in this aspect of this disclosure can intuitively display a virtual piece battle formation of an opposing player in the first board area of the player, an information reach rate of piece formation information is improved, which is beneficial to reducing load of memorizing and mirror-adjusting the piece formation information by the player, thereby improving efficiency and accuracy of grasping the piece formation information by the player.

### BRIEF DESCRIPTION OF THE DRAWINGS

FIG. 1 is a structural block diagram of a computer system according to an aspect of this disclosure.

FIG. 2 is a flowchart of a match interaction method for a turn-based board game according to an aspect of this disclosure.

FIG. 3 is a schematic interface diagram of a match interface of a turn-based board game according to an aspect of this disclosure.

FIG. 4 is a schematic card diagram of a piece card according to an aspect of this disclosure.

FIG. 5 is a schematic card diagram of an effect card according to an aspect of this disclosure.

FIG. 6 is a schematic card diagram of an equipment card according to an aspect of this disclosure.

FIG. 7 is a schematic card diagram of an avatar card according to an aspect of this disclosure.

FIG. 8 is a flowchart of a match interaction method for a turn-based board game according to an aspect of this disclosure.

FIG. 9 is a schematic interface diagram of an avatar selection interface according to an aspect of this disclosure.

FIG. 10 is a schematic interface diagram of a match interface in a battle preparation phase according to an aspect of this disclosure.

FIG. 11 is a schematic interface diagram of playing a card in a battle preparation phase according to an aspect of this disclosure.

FIG. 12 is a schematic diagram of an upgrade process of an upgrade button according to an aspect of this disclosure.

FIG. 13 is a schematic diagram of an upgrade process of an upgrade button according to an aspect of this disclosure.

FIG. 14 is a schematic interface diagram of a match interface in a battle phase according to an aspect of this disclosure.

FIG. 15 is a schematic interface diagram of a settlement interface according to an aspect of this disclosure.

FIG. 16 is a flowchart of a method for displaying a virtual piece battle formation according to an aspect of this disclosure.

FIG. 17 is a schematic diagram of a virtual match interface of a first account according to an aspect of this disclosure.

FIG. 18 is a schematic diagram of a virtual piece battle formation of a second account according to an aspect of this disclosure.

FIG. 19 is a schematic diagram of an effect of a virtual piece battle formation in a first board area according to an aspect of this disclosure.

FIG. 20 is a schematic diagram of a process of a virtual piece battle formation of a second account according to an aspect of this disclosure.

FIG. 21 is a schematic diagram of freezing display of a virtual piece battle formation of a second account according to an aspect of this disclosure.

FIG. 22 is a flowchart of a method for displaying a virtual piece battle formation according to another aspect of this disclosure.

FIG. 23 is a schematic diagram of a counter relationship indication element according to an aspect of this disclosure.

FIG. 24 is a flowchart of a method for displaying virtual pieces having a battle matching relationship according to an aspect of this disclosure.

FIG. 25 is a schematic diagram of a second virtual piece displayed in a second sub-area according to an aspect of this disclosure.

FIG. 26 is a schematic diagram of adjusting a virtual piece battle formation of a first account according to an aspect of this disclosure.

FIG. 27 is a structural block diagram of an apparatus for displaying a virtual piece battle formation according to an aspect of this disclosure.

FIG. 28 is a structural block diagram of another apparatus for displaying a virtual piece battle formation according to an aspect of this disclosure.

FIG. 29 is a structural block diagram of a computer device according to an aspect of this disclosure.

### DETAILED DESCRIPTION

The following describes technical solutions in aspects of this disclosure with reference to the accompanying drawings. The described aspects are some of the aspects of this disclosure rather than all of the aspects. Other aspects are within the scope of this disclosure.

Examples of terms involved in the aspects of the disclosure are briefly introduced. The descriptions of the terms are provided as examples and are not intended to limit the scope of the disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include A, B, C or any combination thereof. References to one of A or B and one of A and B are intended to include A or B or (A and B). The use of “one of” does not preclude any combination of the recited elements when applicable, such as when the elements are not mutually exclusive.

In the related technology, in an Auto Chess game, respective virtual piece battle formations are separately displayed in player's perspectives. A player switches from the player's own perspective to an opposing player's perspective to observe the virtual piece battle formation owned by the opposing player, to plan the virtual piece battle formation owned by the player. Because the player needs to switch perspectives repeatedly when viewing the virtual piece battle formations of the player and the opposing player, operations are complex, and human-computer interaction efficiency is low. In addition, game screens need to be switched during switching of perspectives, and a lot of computing resources need to be consumed to load the game screens. Repeated switching of game screens easily causes freezing of game screens, imposing load on running of a computer device. In addition, in the related technology, after switching to the opposing player's perspective, the player obtains piece formation information from a mirrored perspective, and after switching back to the player's perspective, the player needs to convert the observed piece formation information of the opposing player into the player's own perspective through imagination. Therefore, an information reach rate of the piece formation information is low, which increases load of memorizing and mirror-adjusting the piece formation information by the player, leading to reduced efficiency and accuracy of grasping the piece formation information by the player.

Based on this, an aspect of this disclosure provides a method for displaying a virtual piece battle formation, so that virtual piece battle formations of different accounts can be directly observed without repeatedly switching perspectives. For a detailed process, refer to the following aspects.

First, terms in aspects of this disclosure are described.

A turn-based board game is a board game in which “pieces” are arranged in advance before a board game battle is started, and in a battle process, the “pieces” can automatically battle based on the preset arrangement. A “piece” is represented by a virtual character, and for example, may be referred to as a virtual hero. In a battle process, the virtual character automatically casts various skills to battle. Battles are turn-based. When “pieces” on one side of the battle are eliminated (that is, the health points of a virtual character drop to zero), the side loses the current turn of battle. In some aspects, in addition to “piece-type virtual characters” engaging in a match, two sides of a battle are each provided with an avatar character representing a current user participating in the battle. The avatar character cannot be moved to a battle area or a piece standby area as a “piece”. The avatar character is also provided with health points (or health). The health points of the avatar character are reduced (winning a battle) or kept unchanged (losing a battle) based on a battle result of each round. When the health points of the avatar character drop to zero, the user corresponding to the avatar character leaves the battle, and the remaining users continue with the battle. In some aspects, the turn-based board game includes Auto Chess.

Auto Chess is a multiplayer turn-based strategy game featuring in-game collectible hero pieces. For example, there are a total of eight or six players in a game, and the players each occupy an area on a board. Two of the multiple players engage in a one-on-one battle. Each turn of a battle includes two phases a battle preparation phase and a battle phase. In the battle preparation phase, a user purchases pieces (heroes) in a shop and arranges the pieces on a board. In the battle phase, the lineups on two sides are locked, and the pieces automatically battle until all the pieces on one side are wiped out. A side with all pieces eliminated is the losing side of the current round, and an amount of health is deducted from the side. The game rounds are continuously repeated, new opponents are matched, and a player is eliminated when their health points drop to 0 or below. The last remaining player wins the game.

A board is an area for battle preparation and battling in a battle interface of a turn-based board game. The board may be any one of a two-dimensional virtual board, a 2.5-dimensional virtual board, and a three-dimensional virtual board. This is not limited in this disclosure.

A related board of Auto Chess is divided into a battle area and a piece standby area. The battle area includes a plurality of identically sized cells, and the cells are configured for placing pieces battling in the battle process. The piece standby area includes a plurality of standby piece positions, the standby piece positions are configured for placing standby pieces, and the standby pieces do not participate in the battle process and can be dragged and placed in the battle area in the battle preparation phase. The board area provided in this disclosure does not include the piece standby area and includes only the battle area.

Regarding an arrangement manner of the cells in the battle area, in some aspects, the battle area includes n (rows)×m (columns) cells. For example, n is an integer multiple of 2, and two adjacent rows of cells are aligned, or two adjacent rows of cells are staggered. In addition, the battle area is equally divided into two parts along the rows, which are respectively a friendly battle area and an enemy battle area, users participating in the battle are respectively located on upper and lower sides of the battle interface, and in the battle preparation phase, a user can place pieces only in the friendly battle area. In some other aspects, the battle area is equally divided into two parts along the columns, which are respectively a friendly battle area and an enemy battle area, and users participating in the battle are respectively located on left and rights side or upper and lower sides of a battle interface. The shape of the cell may be any one of a square, a rectangle, a circle, or a hexagon.

A card is a common term of a game type, and derives from a tabletop game. Different from chess in which piece models are directly manipulated, a card represents game content on cards. Compared with pieces, cards can more conveniently convey some text descriptions, card attribute information, and some key numerical values. “Card-based representation” converts hero resources into card resources, facilitating reading and classification of card effects by players, and enabling conveyance of information across more dimensions.

Energy is a resource form in a game. In this disclosure, energy is defined as a resource for playing a card by a player, and when a card is played, energy of a corresponding numerical value marked on the card needs to be consumed.

Equipment: In an Auto Chess game, for example, each piece can wear three pieces of equipment (or another quantity of pieces of equipment), and the equipment may provide a hero with attributes such as attack power, defense power, and health points or effects such as healing, penetration, and shield. An Auto Chess game in the related technology can have a PvE round in an example. After defeating creeps, a player obtains equipment dropped by the creeps, picks up the equipment, and stores the equipment in an inventory. Moreover, equipment can also be synthesized from individual pieces to obtain higher-quality equipment.

An avatar is a virtual character played by a player. Each avatar has unique special abilities and can assist a player in achieving better gameplay.

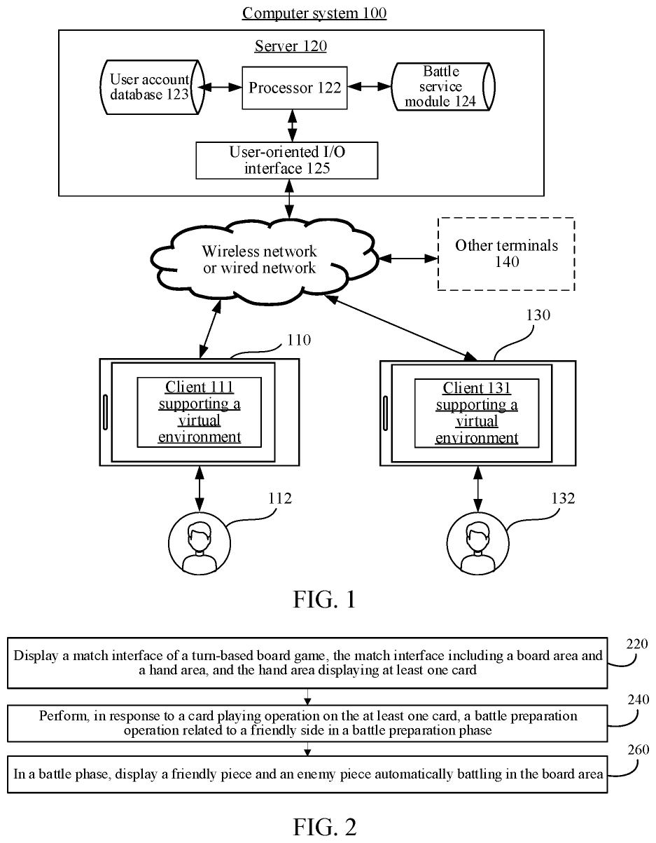

FIG. 1 is a structural block diagram of a computer system according to an aspect of this disclosure. The computer system 100 includes a first terminal 110, a server 120, and a second terminal 130.

A client 111 supporting a virtual environment is installed and run on the first terminal 110. The client 111 may be a turn-based board game program. When the first terminal runs the client 111, a user interface of the client 111 is displayed on a screen of the first terminal 110. The client may be a client of an Auto Chess game. The first terminal 110 is a terminal used by a first user 112. The first user 112 arranges pieces in a battle area of a board using the first terminal 110 in a battle preparation phase of a match. The first terminal 110 or the server 120 automatically controls the pieces to battle in a battle phase based on attributes, skills, and the arrangement of the pieces in the battle area. A client 131 supporting a virtual environment is installed and run on the second terminal 130. The client 131 may be a turn-based board game program. When the second terminal 130 runs the client 131, a user interface of the client 131 is displayed on a screen of the second terminal 130. The client may be a client of an Auto Chess game. The second terminal 130 is a terminal used by a second user 132. The second user 132 arranges pieces in a battle area of a board using the second terminal 130 in the battle preparation phase of the match. The second terminal 130 or the server 120 automatically controls the pieces to battle in the battle phase based on attributes, skills, and the arrangement of the pieces in the battle area.

In some aspects, the pieces arranged by the first user using the first terminal 110 and the pieces arranged by the second user using the second terminal 130 are located in different battle areas on the same board, that is, the first user and the second user are located in the same board of the same match. Alternatively, the pieces arranged by the first user using the first terminal 110 and the pieces arranged by the second user using the second terminal 130 are located on different boards, that is, the first user and the second user are located in different boards of the same match. In an aspect, six user accounts participate in a match of the turn-based board game. The six user accounts are matched in pairs in each turn, and the two matched user accounts battle in the same board in the current turn.

In some aspects, the client installed on the first terminal 110 is the same as that installed on the second terminal 130, or the clients installed on the two terminals are clients of the same type on different operating system platforms (Android or iOS). The first terminal 110 can refer to one of a plurality of terminals, and the second terminal 130 can refer to another one of the plurality of terminals. In this aspect, the first terminal 110 and the second terminal 130 are only used as an example for description. Device types the first terminal 110 and the second terminal 130 are the same or different. The device types include at least one of a smartphone, a tablet computer, an e-book reader, an MP3 player, an MP4 player, a laptop computer, and a desktop computer. In the following aspects, an example in which a terminal includes a smartphone is used for description.

In an aspect, more or fewer terminals may be provided. For example, there may be only one terminal (e.g., a user plays a match against the artificial intelligence), or there may be six, eight, or more terminals. A quantity and device types of terminals are not limited in the aspects of this disclosure. FIG. 1 shows only two terminals, but a plurality of other terminals 140 may access the server 120 in different aspects. In some aspects, one or more terminals 140 are terminals corresponding to a developer. A development and editing platform of a client supporting a virtual environment is installed on the terminal 140, and the developer may edit and update the client on the terminal 140.

The server 120 includes at least one of one server, a plurality of servers, a cloud computing platform, or a virtualization center. The server 120 is configured to provide backend services for a client (a client of a turn-based board game/a client of an Auto Chess game) supporting a three-dimensional virtual environment. In some aspects, the server 120 performs primary computing tasks, and the terminal performs secondary computing tasks. Alternatively, the server 120 performs secondary computing tasks, and the terminal performs primary computing tasks. Alternatively, the server 120 and the terminal perform cooperative computing using a distributed computing architecture.

In some aspects, the server 120 includes a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and the other terminals 140, such as profile pictures of the user accounts, nicknames of the user accounts, combat power indexes of the user accounts, and service areas of the user accounts. The battle service module 124 is configured to provide a plurality of battle rooms for users to battle against each other. The user-oriented I/O interface 125 is configured to establish communication with the first terminal 110 and/or the second terminal 130 via a wireless network or a wired network to exchange data.

An aspect of this disclosure provides a turn-based board game (an Auto Chess game) based on card operations. Various complex operations such as shop purchase, shop upgrade, piece battle preparation, piece deployment, piece upgrade, and equipment attachment to pieces in related Auto Chess games are all streamlined into a card playing procedure. On one hand, a card-based playing procedure is relatively simple, and is suitable for use on a small-screen terminal such as a mobile phone or a tablet computer. In another aspect, a three-dimensional model of a virtual piece can carry only limited text information, and a card can carry more information such as “tags”, “numerical values”, “attributes”, and “entry effects” on a card face, thereby improving utilization efficiency of a display area in which cards are located.

FIG. 2 is a flowchart of a match interaction method for a turn-based board game according to an aspect of this disclosure. In this aspect, an example in which the method is performed by a terminal is used. A client supporting a turn-based board game runs on the terminal. The method includes the following operations:
Operation 220: Display a match interface of a turn-based board game, the match interface including a board area and a hand area, and the hand area displaying at least one card.

The match interface is an interface on which two player objects engage in a turn-based battle in the turn-based board game. The player object may be understood as at least one concept of a user, an account, a player, an avatar, and a virtual avatar.

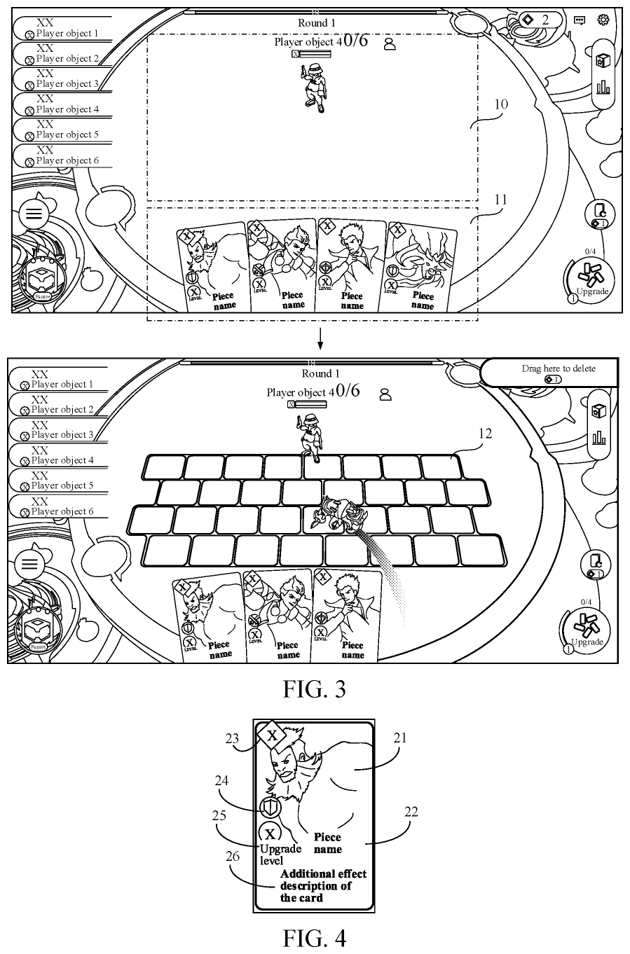

With reference to FIG. 3, the match interface includes a board area 10 and a hand area 11. The board area 10 is configured for accommodating at least one friendly piece and at least one enemy piece participating in a combat. The board area 10 includes a plurality of cells 12 arranged in an array. These cells 12 are always displayed or displayed at certain times. In some aspects, the board area 10 is a two-dimensional board or a three-dimensional board. In this aspect, an example in which the board area 10 is a three-dimensional board observed from the top is used for description. A three-dimensional board in this disclosure means that the board is in a three-dimensional environment, rather than that the board itself is in a three-dimensional form. The hand area 11 is configured for displaying at least one card held by or distributed to a friendly player object. The at least one card can be a plurality of cards in an example. The at least one card includes at least one of a card automatically drawn or distributed by a background program to the friendly player object, a card obtained after some cards having a card-drawing effect are played, and an avatar card that can be obtained due to an avatar skill. The plurality of cards is subject to an upper quantity limit, for example, 8, and excess cards are automatically discarded. In some aspects, the plurality of cards is arranged in the hand area 11 in a fan shape, and an arrangement order may be determined based on at least one factor of drawing time, card types, a quantity of cards of the same type, a quantity of identity cards, and card rarity. In some aspects, the at least one card held by the friendly player object is subject to an upper limit, for example, 8 or 10, and excess cards are discarded when the upper limit is exceeded. The friendly player object may play all or some cards in each turn of battle. In some aspects, in each battle turn, the friendly player object may alternatively exchange all or some cards. In some aspects, different cards have different card types. Different card types have different battle preparation functions.

A match in the turn-based board game includes a plurality of turns. Each turn includes a battle preparation phase and a battle phase.

Operation 240: Perform, in response to a card playing operation on the at least one card, a battle preparation operation related to the friendly side in the battle preparation phase.

The card playing operation is an operation of playing one or more held cards. For example, the card playing operation is an operation of dragging a selected card toward the board area. Alternatively, the card playing operation includes a first tap operation and a second tap operation, the first tap operation is an operation of selecting a card with a tap, and the second tap operation is an operation of tapping a cell in the board area. A specific form of the card playing operation is not limited in this aspect of this disclosure. In some aspects, a function of intelligently recommending a card to play may further be provided to play cards in place of the friendly player object in some turns. For example, the client intelligently recommends cards to play in first several turns of a new player. The at least one friendly piece is a virtual piece participating in a battle in at least one turn (including the current turn). When the board area is a two-dimensional board, the virtual piece is a two-dimensional piece, and is displayed as a two-dimensional icon or a two-dimensional image. When the board area is a three-dimensional board, the virtual piece is a three-dimensional piece, and is displayed as a three-dimensional icon or a three-dimensional image. In an initial state, there may be zero friendly pieces located in the board area, and friendly pieces are added, deleted, or supplemented in the board area by the friendly player object. Friendly pieces that survive a previous turn may be automatically carried over to a next turn. A display state of the selected card is different from a display state of an unselected card. In some aspects, the selected card has a highlighting effect, and the highlighting effect includes: a bold frame, a brightened frame, a dynamic frame, and a movement of a placement position in a card queue toward the board area by a preset distance.

The battle preparation operation includes at least one of: adding a friendly piece, removing a friendly piece, upgrading a friendly piece, adding equipment to a friendly piece, removing equipment from a friendly piece, and being buffed by a friendly piece. Because different card types have different effects, the battle preparation operation is performed on at least one friendly piece in the board area based on a card type of the selected card. In the battle preparation phase, a friendly player object prepares at least one friendly piece in the board area, and an enemy player object prepares at least one enemy piece in the board area.

Operation 260: In the battle phase, display the friendly piece and the enemy piece automatically battling in the board area.

A process of automatic battling between the friendly piece and the enemy piece in the board area does not require manual control by the friendly player object. The client or the server automatically controls, based on factors such as cell positions of the pieces on the two sides on the board, piece attributes, piece levels, piece skills, and joint attribute enhancement between pieces, the pieces on the two sides to battle until pieces on one side are wiped out. Both the friendly player object and the enemy player object have health points. After the current turn ends, a portion of health points is deducted from the health points of a player object on the losing side. The portion of health points may be determined based on a quantity of remaining pieces on the winning side, or may be fixed values. This is not limited in this aspect.

In summary, in the method provided in this aspect, a “card” mechanism is introduced into the turn-based board game, and a plurality of battle preparation operations are streamlined and integrated into a process of playing a plurality of cards, thereby canceling a shop concept, and a player does not need to complete obtaining, upgrading, and battling of pieces based on repeated interactions between a plurality of sub-areas such as a shop, a piece battle preparation area, and a piece battle area on a related battle interface. A related purchase process in which a user needs to actively select pieces is replaced with passive reception of distributed cards, and a game system handles some complex operations for users, and users can complete various battle preparation operations by using card playing operations basically the same as those of a card game, thereby improving human-computer interaction efficiency.

Especially when a turn-based board game is operated on a small-screen terminal such as a mobile phone or a tablet computer, a player may complete various battle preparation operations based on limited operations in the hand area, which can improve human-computer interaction efficiency compared with related Auto Chess games.

Card type classification: In some aspects, the card type includes at least one of a piece card, an effect card, an equipment card, and an avatar card.

Piece card: The piece card is a card configured to call a friendly piece or increase a piece level of a friendly piece in the board area. FIG. 4 is a schematic card diagram of a piece card. The piece card displays at least one item of the following information: a piece image 21, a piece name 22, an energy value 23 consumed to play the card, a piece type or faction 24 to which the piece belongs, an increased level 25 of the piece after the card is played, and an additional effect description 26 of the piece. The piece image 21 may be at least one of a profile picture, an icon, a portrait, a full-body image, and a display animation of a virtual piece. In FIG. 4, an example in which the piece image 21 is a portrait of a virtual piece is used for description. The piece name 22 is a name of a virtual piece. Taking an example in which the virtual piece is a hero, the piece name is a hero name. The energy value 23 is an energy value that needs to be consumed to play the piece card, and the energy value is an integer. Energy is a resource in a turn-based board game. In some aspects, different amounts of energy are consumed to play cards of different rarities. For example, 0, 1, 2, 3, and 4 points of energy respectively need to be consumed to play cards of five different rarities. The piece type 24 is a classification attribute indicating a character played by a piece in a combat process. In an example, different pieces may be classified into at least one of the following types: tank, warrior, assassin, mage, marksman, and support. A faction is a classification attribute indicating the same piece group to which pieces belong in a virtual world view. In an example, different pieces may be classified into at least one of the following factions: the Great Wall, the Three Kingdoms, Xuanyong, Mechanism, Yaotian, and Chang'an. For instance, in the virtual worldview, two pieces that are Great Wall Guards both belong to the Great Wall faction. In different aspects, the piece type and the faction may be considered as a same classification attribute. In this aspect, an example in which the piece type and the faction are different classification attributes is used. The increased level 25 of the piece after the card is played is an upgraded piece level for an existing piece having a same name (that is, a same piece) after the card is played in a case that the piece exists in the board area. For example, the level 25 is Level 3, and the piece having the same name is originally Level 2. After the card is played, the piece having the same name is upgraded to Level 5. In some aspects, after being played, the cards of different rarities increase different levels for a piece having a same name. For example, after the cards of five different rarities are played, levels by which the piece having the same name is increased are respectively 1, 2, 3, 4, and 5 levels. The additional effect description 26 of the piece is an effect description of an additional effect of the piece. The additional effect may be triggered to take effect as soon as a card is played, or may take effect when a trigger condition is met in a battle process. For example, an exclusive skill of a piece 1 is that when the piece 1 is on the battlefield, each time another friendly piece in the board area is sold, a friendly piece whose piece type is “tank” on the battlefield is selected in various manners, and a piece level of the selected friendly piece on the battlefield is increased by a first value. The first value is half a level of the sold piece.

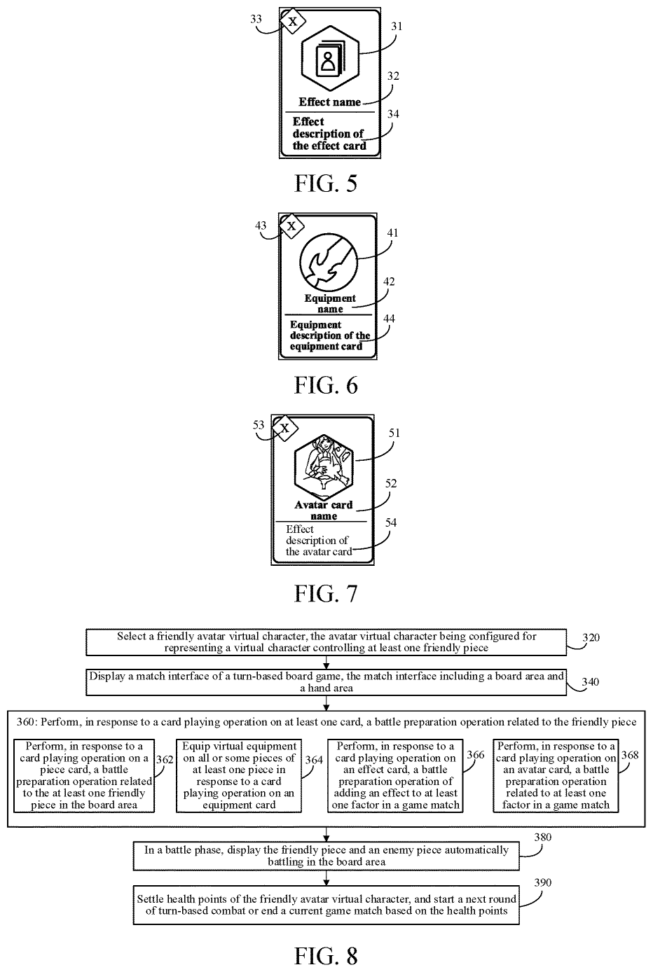

Effect card: The effect card is a card configured to apply an effect to at least one game factor in a game match. The at least one game factor includes a piece, a skill, equipment, a boost effect, a level, a combat process, a hand obtaining process, and the like. FIG. 5 is a schematic card diagram of an effect card. The effect card displays at least one item of the following information: an effect icon 31, an effect name 32, an energy value 33 consumed to play the card, and an effect description 34 of the effect card. The effect icon 31 may be an icon configured to represent a buff effect of the effect card. FIG. 5 is described using an icon with a hexagonal frame as an example. The effect name 32 is a name of the effect card or a name of the buff effect. The energy value 33 is an energy value that needs to be consumed to play the effect card, and the energy value is an integer. Energy is a resource in a turn-based board game. In some aspects, different amounts of energy are consumed to play cards of different rarities. For example, 0, 1, 2, 3, and 4 points of energy need to be respectively consumed to play cards of five different rarities. The effect description 34 of the effect card is configured for describing an effect of the effect card after use. The effect of the effect card includes but is not limited to at least one of the following: 1. increasing a probability and/or a quantity when a friendly avatar obtains piece cards; 2. increasing a probability or a quantity when a friendly avatar obtains same-name piece cards associated with pieces on the battlefield; 3. reducing energy that needs to be consumed to obtain a piece card by a friendly avatar; 4. increasing a quantity when a friendly avatar exchanges piece cards; 5. reducing energy that needs to be consumed to exchange piece cards by a friendly avatar; 6. increasing a piece level of at least one piece on the battlefield; 7.adding equipment to at least one piece on the battlefield; 8. increasing an equipment level for at least one piece on the battlefield; 9. reducing energy consumed to play/exchange cards; 10.increasing obtaining probabilities of some cards; 11. increasing obtaining quantities of some cards; and 12. increasing card exchange opportunities, and so on. Details are not described one by one again.

For example, an effect of a “Pair Up” card is obtaining two identical hero cards in various manners; an effect of a “Talent Search” card is choosing one out of three hero cards of the highest quality that can be obtained under a current avatar level; an effect of a “Copy” card is obtaining one card having a same name as a hero card on the battlefield in various manners; an effect of a “Bountiful Harvest” card is immediately adding hand cards to a quantity of 5; an effect of a “Random Boost” card is increasing the level of one random hero on the battlefield by 5; an effect of a “One More Time” card is drawing one card and additionally obtaining one additional free card exchange in a current round; an effect of a “Wish” card is reducing an energy value to be consumed by every card by 1; and an effect of “Add Card” is drawing two cards.

In some aspects, the effect card may be classified into at least one of a universal effect card, a piece type effect card, and a faction effect card. The universal effect card is an effect card whose card attribute is not related to a piece type/faction, and the card attribute includes at least one of an obtaining condition, a use condition, a card effect, and an effect range. The piece type effect card is an effect card whose card attribute is related to a piece type, for example, a card indicating that only a card of a specified piece type can obtain or use or enjoy an effect. The faction effect card is an effect card whose card attribute is related to a faction, for example, a card indicating that only a card of a specified faction can obtain or use or enjoy an effect. For example, an effect card of a piece type may be obtained with a probability only when a piece card of the piece type is played.

Equipment card: The equipment card is a card configured to equip at least one friendly piece with equipment. FIG. 6 is a schematic card diagram of an equipment card according to an aspect of this disclosure. The equipment card displays at least one item of the following information: an equipment icon 41, an equipment name 42, an energy value 43 consumed to play the card, and an equipment description 44 of the equipment card. The equipment icon 41 may be an icon configured to represent an equipment image or an equipment effect. FIG. 6 is described using an icon with a circular frame as an example. The equipment name 42 is a name of the equipment card or a name of equipment. Different equipment can enhance combat abilities of a friendly piece or weaken combat abilities of an enemy piece in various dimensions such as health, armor, defense, and mana. The energy value 43 is an energy value that needs to be consumed to play the equipment card, and the energy value is an integer. Energy is a resource in a turn-based board game. In some aspects, different amounts of energy are consumed to play cards of different rarities. For example, 0, 1, 2, 3, and 4 points of energy need to be respectively consumed to play cards of five different rarities. In some aspects, energy values consumed by different cards may be periodically or irregularly adjusted based on game balance. The equipment description 44 of the equipment card is configured for describing effects of equipment after being worn.

Avatar card: The avatar card is a card obtained through an avatar skill of an avatar virtual character. The avatar card may be a card triggered to be obtained through a passive skill of an avatar virtual character, a card that can be obtained by an avatar virtual character, a card that can be used by an avatar virtual character, a card exclusive to an avatar virtual character, or the like. This is not limited in this aspect of this disclosure. FIG. 7 is a schematic card diagram of an avatar card according to an aspect of this disclosure. The avatar card displays at least one item of the following information: a card icon 51, an avatar card name 52, an energy value 53 consumed to play the card, and an equipment description 54 of the avatar card. The card icon 51 may be an icon configured to represent an effect of the card. FIG. 7 is described using an icon with a hexagonal frame as an example. The avatar card name 52 is a name of the avatar card or a name of the effect. The energy value 53 is an energy value that needs to be consumed to play the avatar card, and the energy value is an integer. Energy is a resource in a turn-based board game. In some aspects, different amounts of energy are consumed to play cards of different rarities. For example, 0, 1, 2, 3, and 4 points of energy need to be respectively consumed to play cards of five different rarities. In some aspects, energy values consumed by different cards may be periodically or irregularly adjusted based on game balance. The effect description 54 of the avatar card is configured for describing an effect that can be added after the avatar card is used. Effects of the avatar card may be the same as or similar to those of the piece card, the equipment card, and the effect card, and may alternatively exceed the effect scopes of the piece card, the equipment card, and the effect card. In possible designs of different aspects, the effects of the avatar card may be designed to be in any form of effects such as calling a piece, upgrading a piece, adding equipment, adding a buff effect, reducing energy consumption, and affecting a hand obtaining process. An effect of the avatar card may be designed to affect any process or detail in a game match. This is not limited in this aspect of this disclosure.

It can be known based on the introduction of the foregoing four types of cards that in one aspect, different types of cards have different functions. Shops in related Auto Chess games can be removed based on playing features of cards by using the piece card. An effect button or control in related Auto Chess games can be removed by using the effect card. A PvE round in related Auto Chess games can be removed by using the equipment card. An avatar-related playing features can be integrated by using the avatar card. Based on different types of cards, different mechanisms in the turn-based board game are streamlined into a card playing process, which can reduce user interface elements that need to be displayed on a battle interface, and can also reduce difficulty of operating the friendly player object, thereby improving human-computer interaction efficiency of the friendly player object. In another aspect, compared with a three-dimensional piece that cannot adequately carry text information because the three-dimensional piece can carry limited text information, card features of a two-dimensional card can naturally carry more text information and icon information, so that compared with a related three-dimensional piece in a battle preparation phase, the two-dimensional card can further increase an amount of information carried in a limited display area on a small-screen terminal, thereby improving information conveyance efficiency. The foregoing cards can be played in the battle preparation phase, and some of the cards may be played in a battle phase, for example, some equipment cards, and an effect card for drawing two more cards at once.

Card obtaining manner: A friendly player object obtains at least one card when meeting an obtaining condition. The obtaining condition includes at least one of the following: (1). Obtaining condition 1: A new round of turn-based combat is started. Each time a new round of turn-based combat is started, several cards are obtained. For example, four cards are drawn in the first round of turn-based combat, and two cards are drawn in a subsequent round of turn-based combat. (2). Obtaining condition 2: A preset piece card is used. The preset piece card is a piece card having an additional skill such as drawing, adding, or copying cards. For example, an effect card is additionally obtained during playing of a piece card with a same name corresponding to a piece on the battlefield. (3). Obtaining condition 3: A preset effect card is used. The preset effect card is an effect card having an action effect such as drawing, adding, or copying cards. (4). Obtaining condition 4: A preset avatar card is used. The preset avatar card is an effect card having an action effect such as drawing, adding, or copying cards. (5). Obtaining condition 5: Resources possessed by the friendly side are consumed for exchange. For example, energy is consumed for drawing or exchange. (6). Obtaining condition 6: An avatar level of an avatar virtual character is upgraded. After the avatar level is upgraded, rarer or more cards may be unlocked and obtained. (7). Obtaining condition 7: A card pool level is upgraded. After the card pool level is upgraded, rarer or more cards may be unlocked and obtained. (8). Obtaining condition 8: An operation of purchasing a card. (9). Obtaining condition 9: A preset avatar skill is triggered. The preset avatar skill is a passive skill having an effect such as drawing, adding, or copying cards. For example, one avatar card may be drawn every two turns. One avatar card may be drawn every time three cards are played.

The obtaining conditions may be combined. For example, some cards can be obtained by using a preset avatar card after an avatar level reaches Level 2. The obtaining conditions of different types of cards may be different, or may be the same, or some conditions may be the same and some conditions may be different.

FIG. 8 is a flowchart of a match interaction method for a turn-based board game according to an aspect of this disclosure. In this aspect, an example in which the method is performed by a terminal is used. The method includes the following operations:

### Avatar Selection Phase

Operation 320: Select a friendly avatar virtual character, the avatar virtual character being configured for representing a virtual character controlling at least one friendly piece.

Before a game match is started each time, a friendly player character selects a avatar virtual character. Different avatar virtual characters have different avatar skills. An avatar skill may be related to obtaining an avatar card, but may also be related to other game factors. In some aspects, for different avatar skills, there are some respective passive trigger mechanisms to enable the friendly player character to obtain some cards with effects. For example, a skill effect of an avatar is obtaining one treasure avatar card every time three piece cards are played, and an effect of the treasure avatar card is consuming 1 point of energy to specify in the board area one friendly piece whose level is to be increased by 2. As shown in FIG. 9, before a game match is started, an avatar selection interface is displayed. The avatar selection interface displays avatar virtual characters selected by six player objects. In some aspects, an avatar virtual character 61 by a friendly player object is highlighted. Taking an example in which the friendly player object is a player object 4, an avatar virtual character selected by the player object 4 is highlighted in a manner of standing, having an enlarged size, and being centered in the foreground, and avatar virtual characters selected by other player objects are normally displayed in a manner of sitting, having a normal size, and being distributed on two sides. Several candidate avatar virtual characters 62, for example, candidate avatars 1 to 5, are displayed on the avatar selection interface. Other candidate avatars may be viewed by swiping left and right, or all candidate avatars may be viewed by tapping an “All” button 63. An avatar skill button 64 is further displayed on the avatar selection interface. In response to the avatar skill button 64 being tapped, a name and an effect description of an avatar skill of a currently selected avatar virtual character may be viewed in a pop-up window on the right side.

In some aspects, a message sent by another player and a countdown for selecting an avatar or entering a match are displayed at the top of the avatar selection interface. A text message sending button, a speaker off/on button, and a microphone off/on button are displayed on the left side of the avatar selection interface. After the avatar virtual character selected by the friendly player object is determined, an “OK” button 65 may be tapped to enter a ready state. n player objects participating in a game match engage in turn-based combats in pairs. Each turn includes a battle preparation phase and a battle phase.

### Battle Preparation Phase of Each Turn

Operation 340: Display a match interface of a turn-based board game, the match interface including a board area and a hand area.

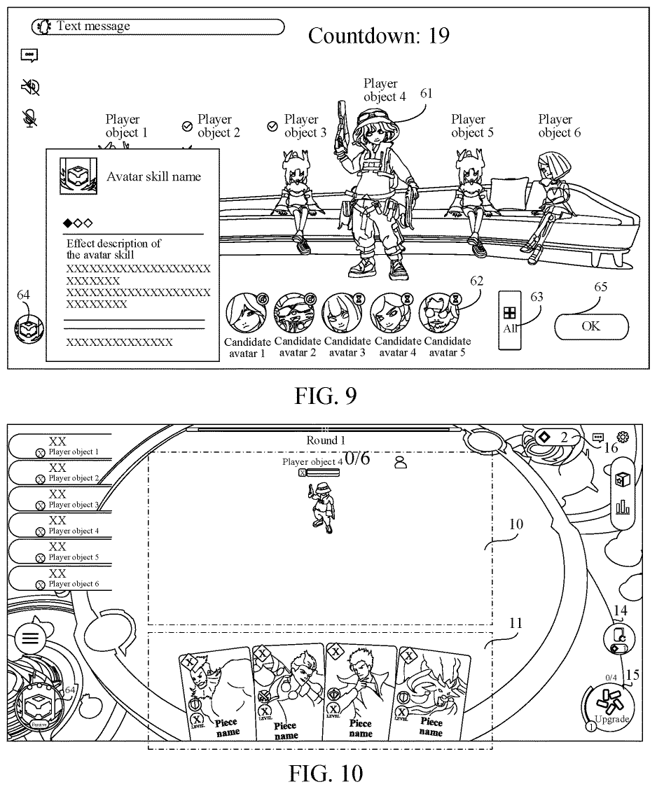

With reference to FIG. 10, a board area 10 is configured for placing at least one friendly piece and at least one enemy piece. In some aspects, the upper half of the board area 10 is configured for placing at least one enemy piece, and the lower half of the board area 10 is configured for placing at least one friendly piece. A hand area 11 is configured for displaying at least one card held by a friendly player object. In an initial state or some cases (for example, all cards in a current turn are played), a quantity of cards displayed in the hand area 11 is 0.

In some aspects, attribute information of n player objects participating in the current game match is further displayed at an upper left corner of the match interface. The attribute information includes at least one of a player nickname, a player profile picture, player health, and an avatar level of a player. An avatar skill button 64 is displayed at a lower left corner of the match interface. A card exchange button 14 and an upgrade button 15 are further displayed at a lower right corner of the match interface. The card exchange button 14 is configured to exchange one or more cards in the hand area 11. The upgrade button 15 is configured to upgrade a level of an avatar virtual character, to unlock rarer cards and capabilities and obtain equipment.

In some aspects, an energy control 16 is further displayed at an upper right corner of the match interface, and the energy control 16 is configured to display an energy value possessed by the friendly player object. Energy is a game resource that may need to be used in each phase of an entire game match. For example, energy needs to be consumed to play a card, energy needs to be consumed to exchange a card, and energy needs to be consumed to upgrade an avatar level.

Operation 360: Perform, in response to a card playing operation on at least one card, a battle preparation operation related to the friendly piece.

The card type includes at least one of a piece card, an equipment card, an effect card, and an avatar card. The friendly player object may perform a battle preparation operation with different functions using card playing operations on different piece cards. This operation includes at least one of the following operations: (1). Operation 362: Perform, in response to a card playing operation on a piece card, a battle preparation operation related to the at least one friendly piece in the board area. (2). Operation 364: Equip virtual equipment on all or some pieces of at least one piece in response to a card playing operation on an equipment card. (3). Operation 366: Perform, in response to a card playing operation on an effect card, a battle preparation operation of adding an effect to at least one factor in the game match. (4). Operation 368: Perform, in response to a card playing operation on an avatar card, a battle preparation operation related to at least one factor in the game match.

Because each round of turn-based combat has a different combat situation, each player object has a different hand, and each player object has a different playing habit, a quantity of times and a sequence of performing operation 362, operation 364, operation 366, and operation 368 in each round of turn-based combat may vary. This is not limited in this aspect.

For operation 362 (the piece card): In some aspects, cards located in the hand area include a first piece card. A first friendly piece is added to the board area in response to a card playing operation on the first piece card, and the first friendly piece is a piece corresponding to the first piece card. In some aspects, the first friendly piece is a piece that is not called to the board area. That is, when the first friendly piece does not exist in the board area, the first friendly piece is added to the board area in response to the card playing operation on the first piece card. At least two candidate cells are displayed in the board area in response to the card playing operation on the first piece card, and a first indication element corresponding to the first piece card is displayed. The first indication element includes at least one of a reduced-size first piece card, a first friendly piece, and a first indication arrow. The first friendly piece is added to a first candidate cell in response to a drag operation of dragging the first indication element to the first candidate cell. The first candidate cell is one of the at least two candidate cells. The at least two candidate cells may be all candidate cells, or may be candidate cells belonging to the friendly side. The at least two candidate cells may always be displayed, or may be displayed when a card playing operation is detected.

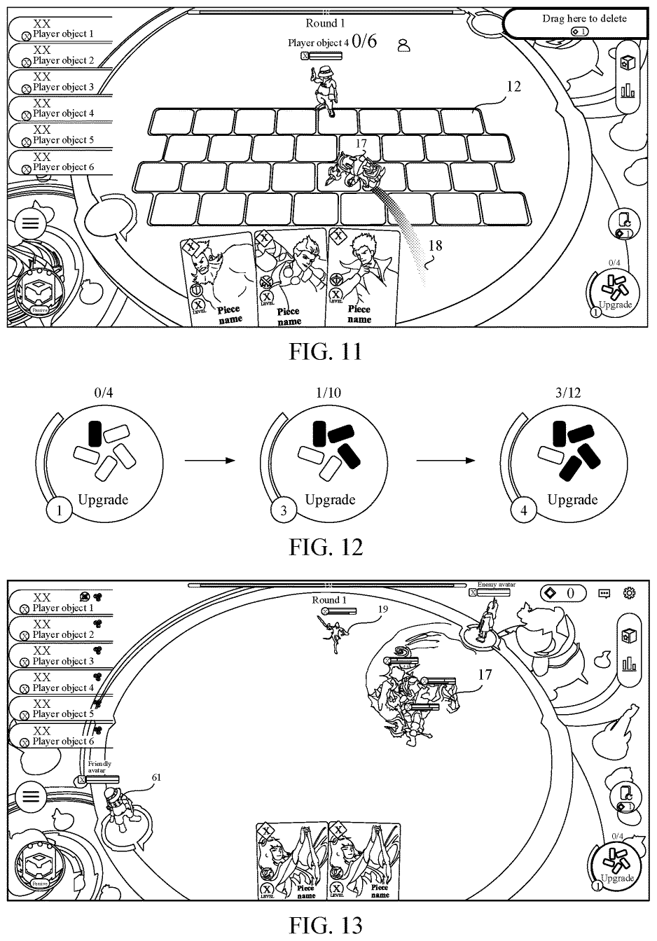

An example in which the first piece card is the fourth card in FIG. 10 is used. With reference to FIG. 11, in response to a drag operation on the first piece card, a first friendly piece 17 and a first indication arrow 18 are displayed. The first friendly piece 17 is a three-dimensional piece, and slides following a real-time position of the drag operation. A start point of the first indication arrow 18 is a position of the first piece card before being played, and an end point is the real-time position of the drag operation. When a hand release position of the drag operation is in the first candidate cell, the first friendly piece 17 is called to the first candidate cell. It can be known based on FIG. 11 that, in the interaction manner, a piece battle preparation area is removed, and the hand area provides both piece obtaining and battle preparation functions, so that one display area achieves multiple functions, thereby improving human-computer interaction efficiency.

In some aspects, cards located in the hand area include a second piece card. In response to a card playing operation on the second piece card and a second friendly piece already exists in the board area, a piece level of the second friendly piece is upgraded in the board area, and the second friendly piece is a piece corresponding to the second piece card. The card playing operation on the second piece card may be alternatively a drag operation. However, because the second friendly piece already exists in the board area, the drag operation can be completed when a hand release position of the drag operation is at any position in the board area, and can take effect without requiring the friendly player object to accurately drag the second piece card onto the second friendly piece.

For operation 364 (the equipment card): In some aspects, cards located in the hand area include an equipment card. In response to a card playing operation on the equipment card, a second indication element corresponding to the equipment card is displayed. The second indication element includes at least one of a reduced-size equipment card, virtual equipment corresponding to the equipment card, and a second indication arrow. Virtual equipment is equipped on the second friendly piece in response to a drag operation of dragging the second indication element to the second friendly piece. The second friendly piece is a friendly piece that already exists in the board area.

For operation 366 (the effect card): In some aspects, cards located in the hand area include an effect card. In response to a card playing operation on the effect card, an effect is added to at least one friendly piece, and/or an effect is added to a card obtaining procedure. Classified by action object, effect cards fall in two types: (1). Type 1: An effect is added to a friendly piece in the board area. (2). Type 2: An effect is added to a card obtaining process.

In response to a card playing operation on an effect card of Type 1, an effect is added to at least one friendly piece. For example, a buff exclusive to a piece type is added, and a joint buff is added when at least two pieces belonging to the same faction exist on the battlefield. In response to a card playing operation on an effect card of Type 2, an effect is added to a card obtaining procedure. For example, two identical piece cards are consecutively drawn.

For operation 368 (the avatar card): At least one of the following battle preparation operations is performed in response to a card playing operation on the avatar card: adding a friendly piece, removing a friendly piece, upgrading a friendly piece, adding an effect to a friendly piece, equipping a friendly piece with equipment, an operation related to card obtaining, an operation related to card selling, an operation related to card exchange, an operation related to a subsequent turn, and an operation related to the health points of a friendly player object. That is, the function of the avatar card is relatively special, and may be any one of functions of a piece card, an equipment card, and an effect card, or may be a function related to a card obtaining procedure, or may be a function related to health points of an avatar. In different design implementations, provided that a function can affect a factor in a game match, the function may be designed to be a function of an avatar card.

In the battle preparation phase, the friendly player object may further use at least one of a card exchange function, a card deletion function, and an avatar level upgrade function. (1). Card exchange function: In the battle preparation phase, the friendly player object may further exchange one or more cards in the hand area, and exchange the one or more cards by tapping a card exchange button. Card exchange needs to consume energy. For example, cards can be exchanged only once in each turn, a plurality of cards can be exchanged each time, and 1point of energy is consumed regardless of a quantity of cards exchanged. (2). Card deletion function: In a card playing process, a card may be deleted or sold by dragging the card to a specified position, resources consumed by the deleted card cannot be recovered, a part of resources may be recovered, or fixed energy can be recovered. For example, 1 point of energy may be obtained each time a card is deleted. (3). Avatar level upgrade function: The friendly player object obtains several pieces of energy in each turn, energy that is not used in the current turn may be accumulated to a next turn, and an avatar level can be upgraded using energy. A higher avatar level indicates rarer cards that can be drawn in each turn, and some new abilities such as talents and purchasable equipment are unlocked at the same time. In some aspects, rarity identifiers of different colors may be displayed on the upgrade button 15, and as the avatar level is upgraded, a rarity identifier corresponding to a current avatar level is illuminated to indicate a card rarity that can be obtained at the current avatar level. The rarity identifiers may be small rounded rectangles shown in FIG. 12 as an example, or may be in another shape or form. For example, the friendly player object unlocks cards of Rarities 1, 2, 3, 4, and 5 respectively at Avatar Levels 1, 2, 3, 4, and 5.

### Battle Phase of Each Turn

Operation 380: In the battle phase, display the friendly piece and the enemy piece automatically battling in the board area.

A process of automatic battling between the friendly piece and the enemy piece in the board area does not require manual control by the friendly player object. The client or the server automatically controls, based on factors such as cell positions of the pieces on the two sides on the board, piece attributes, piece levels, piece skills, and joint attribute enhancement between pieces, the pieces on the two sides to battle until pieces on one side are wiped out. FIG. 13 is a schematic diagram of automatic battling between friendly pieces 17 and an enemy piece 19 in melee combat in a board area. None of the actions such as movement, skill casting, and functions of the pieces on two sides in a battle process requires manual control by players.

### Combat Settlement Phase

Operation 390: Settle health points of the friendly avatar virtual character, and start a next round of turn-based combat or end a current game match based on the health points.

Both the friendly player object and the enemy player object have health points. After the current turn ends, a portion of health points is deducted from the health points of a player object on the losing side. The portion of health points may be determined based on a quantity of remaining pieces on the winning side, or may be fixed values. When the health points are reduced to zero, a player object is eliminated from the current game match. When the health points are not reduced to zero, a next round of turn-based combat is started in the current game match, and the player object continues to combat one of the n player objects until being eliminated, or win the current game match as the last one that is not eliminated.

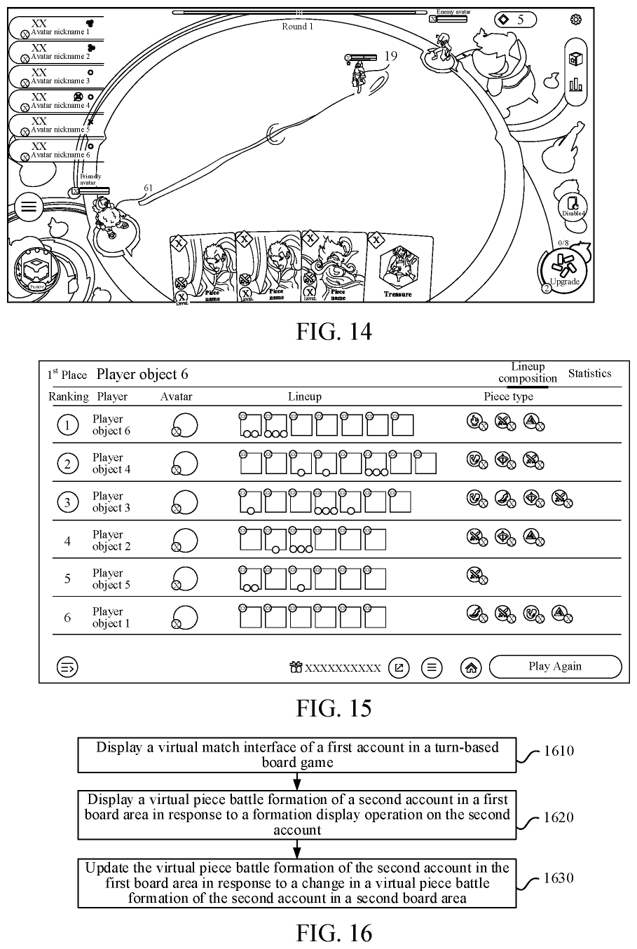

In some aspects, damage calculation is determined based on a quantity of remaining pieces on the winning side. FIG. 14 shows an animation effect of settlement on health points of a friendly piece virtual character 61 when the friendly side is the losing side and one of 19 enemy pieces remains. A health point progress bar may be displayed above the head top the piece virtual character 61. Referring to FIG. 15, settlement information of the current game match is displayed on a settlement interface. The settlement information includes information such as player rankings as well as avatars, lineups, and piece types used by each player.

In summary, in the method provided in this aspect, a “card” mechanism is introduced into the turn-based board game, and a plurality of battle preparation operations are streamlined and integrated into a process of playing a plurality of cards, thereby canceling a shop concept, and a player does not need to complete obtaining, upgrading, and battling of pieces based on repeated interactions between a plurality of sub-areas such as a shop, a piece battle preparation area, and a piece battle area on a related battle interface. A related purchase process in which a user needs to actively select pieces is replaced with passive reception of distributed cards, and a game system handles some complex operations for users, and users can complete various battle preparation operations by using card playing operations basically the same as those of a card game, thereby improving human-computer interaction efficiency. Especially when a turn-based board game is operated on a small-screen terminal such as a mobile phone or a tablet computer, a player may complete various battle preparation operations based on limited operations in the hand area, which can improve human-computer interaction efficiency compared with related Auto Chess games. According to the method provided in this aspect, shops in related Auto Chess games can be removed based on playing features of cards by using the piece card, and the complex process that a user originally needs to purchase pieces in tens of sellable pieces in the shop is changed to a process in which a game system automatically distributes several cards to a player. The user does not need to manually select cards, thereby reducing a quantity of interaction operations required when the user obtains pieces and an amount of information that the user needs to process. According to the method provided in this aspect, an effect button or control in related Auto Chess games can be removed by using the effect card. A PvE round in related Auto Chess games can be removed by using the equipment card. An avatar-related playing features can be integrated by using the avatar card. Based on different types of cards, different mechanisms in the turn-based board game are streamlined into a card playing process, which can reduce user interface elements that need to be displayed on a battle interface, thereby reducing the time for actively searching for related function entries by a user, and can also reduce difficulty of operating the friendly player object, thereby improving human-computer interaction efficiency of the friendly player object.

With reference to the foregoing overall description of the turn-based board game, FIG. 16 is a flowchart of a method for displaying a virtual piece battle formation according to an aspect of this disclosure. An example in which the method is applied to the first terminal shown in FIG. 1 is used for description. The method includes the following step 1610 to step 1630.

Operation 1610: Display a virtual match interface of a first account in a turn-based board game.

The virtual match interface includes a first board area, the first board area includes virtual pieces deployed by the first account, and the virtual pieces in the first board area are configured for participating in a turn-based virtual battle based on a battle formation.

In some aspects, the virtual match interface further includes a hand area, at least one card is displayed in the hand area, and the card is configured for deploying a virtual piece in the first board area. In some aspects, the card in the hand area includes a piece card, the piece card corresponds to a virtual piece, and the virtual piece may be displayed in a form such as a virtual character, a virtual object, a virtual element, or a virtual hero in the virtual match interface. In a round of virtual battle, if a virtual battle process is displayed from a perspective of the first account, virtual pieces owned by accounts (including the first account and a match account) participating in the battle automatically battle based on respective battle formations of the virtual pieces in the first board area. For example, in the first round of virtual battle, the first account and a second account are matched to perform a virtual battle, and descriptions are provided from the perspective of the first account.

A player to which the first account belongs deploys a virtual piece A and a virtual piece B in the first board area using cards in a hand area of the first account. A player to which the second account belongs deploys a virtual piece C and a virtual piece D in the first board area using cards in a hand area of the second account. A battle formation of the virtual piece A and the virtual piece B is different from a battle formation of the virtual piece C and the virtual piece D. In a virtual battle process, there is a battle matching relationship between the virtual piece A and the virtual piece C, so that the virtual piece A and the virtual piece C automatically battle against each other, and there is a battle matching relationship between the virtual piece B and the virtual piece D, so that the virtual piece B and the virtual piece D automatically battle against each other.

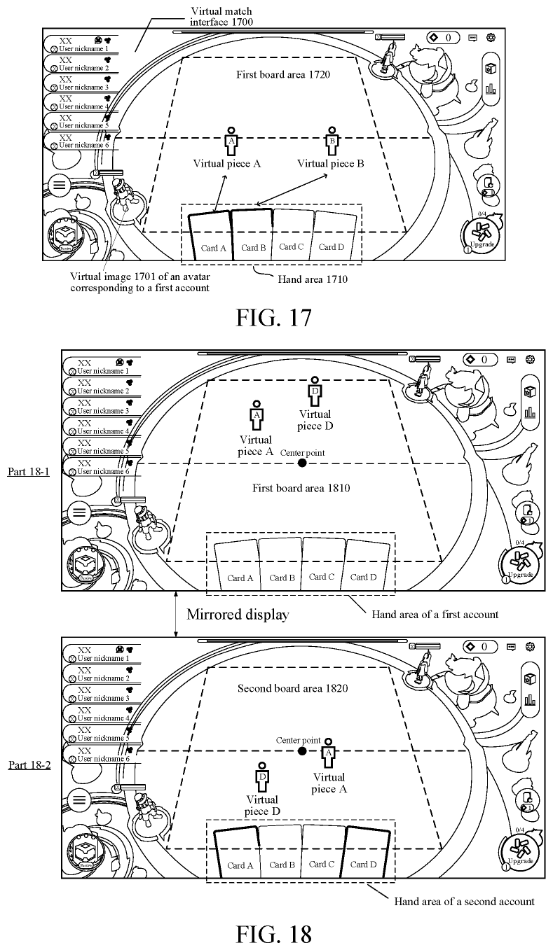

In the battle process, if a virtual piece has defeated an opposing virtual piece in the current battle, the winning virtual piece may also continue to assist a friendly virtual piece in automatically battling against the remaining opposing virtual pieces. For example, the virtual piece A automatically battles against the virtual piece C, and the virtual piece B automatically battles against the virtual piece D. If the battle between the virtual piece B and the virtual piece D is not finished yet when the virtual piece A has defeated the virtual piece C, the virtual piece A automatically assists the virtual piece B in launching an attack to the virtual piece D. For example, FIG. 17 is a schematic diagram of a virtual match interface of a first account. The virtual match interface 1700 displays a virtual image 1701 of an avatar corresponding to the first account, a hand area 1710, and a first board area 1720. The hand area 1710 includes a plurality of piece cards, and the piece cards are configured for deploying corresponding virtual pieces in the first board area 1720. For example, the hand area 1710 includes a piece card A, a piece card B, a piece card C, and a piece card D. These piece cards are cards owned by the first account and respectively correspond to the following virtual pieces: a virtual piece A, a virtual piece B, a virtual piece C, and a virtual piece D. In some aspects, after the piece card A and the piece card B are selected, the virtual piece A and the virtual piece B are correspondingly deployed in the first board area 1720.

Operation 1620: Display a virtual piece battle formation of a second account in the first board area in response to a formation display operation on the second account.

The virtual piece battle formation of the second account is a battle formation of virtual pieces deployed by the second account in a second board area, and the second board area is an area displayed in a virtual match interface of the second account.

In some aspects, the virtual piece battle formation of the second account is displayed in the first board area in response to the formation display operation on the second account in a battle preparation phase of an n^{th} round of virtual battle. n is a positive integer. In other words, in the battle preparation phase, the virtual piece battle formation of the second account may be displayed in the first board area of the first account.

In some aspects, the first board area includes a first sub-area and a second sub-area; and the first sub-area is configured for displaying the virtual pieces deployed by the first account, the second sub-area is configured for displaying virtual pieces deployed by another account, and the another account is an account other than the first account that participates in the game match in the turn-based board game. The virtual piece battle formation of the second account is displayed in the second sub-area of the first board area in response to the formation display operation on the second account, the virtual piece battle formation of the second account being displayed in the second sub-area from a mirrored perspective of the second board area. A difference between the first board area and the second board area lies in that the first board area is a picture displayed on a screen of a terminal where the first account is logged in, that is, a board area picture observed from a perspective of the first account. The second board area is a picture displayed on a screen of a terminal where the second account is logged in, that is, a board area picture observed from a perspective of the second account. Display effects of a virtual piece battle formation of a same account in board areas of different accounts feature a center mirroring effect. In other words, during switching of accounts, the virtual piece battle formation is centrally mirrored around a center point of the board area as a mirror flip point.

For example, FIG. 18 is a schematic diagram of a virtual piece battle formation of a second account from perspectives of different accounts. In FIG. 18, the virtual piece battle formation of the second account includes a virtual piece A and a virtual piece D, and the virtual piece A and the virtual piece D are virtual pieces deployed by the second board area in the second account. A part 18-1 is a display effect of the virtual piece battle formation of the second account in a first board area 1810, and a part 18-2 is a display effect of the virtual piece battle formation of the second account in a second board area 1820. The virtual piece battle formations of the part 18-1 and the part 18-2 are centrally mirrored with a center point of a board area as a reference. The first board area 1810 and the second board area 1820 have the same contour, and have a perspective difference. It may be understood that the first board area 1810 and the second board area 1820 are a same board area. As observed from a perspective of a first account, the board area is referred to as the first board area 1810. As observed from a perspective of the second account, the board area is referred to as the second board area 1820.

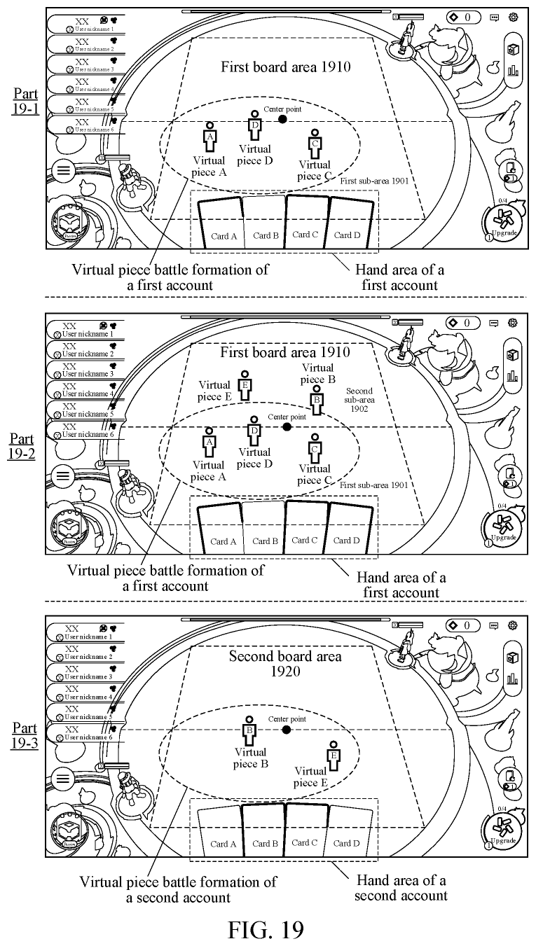

In some aspects, the first account also deploys virtual pieces using piece cards in a hand area, and before or after a response is made to a formation display operation on the second account, effects of virtual piece battle formations of different accounts displayed in the first board area are shown in FIG. 19. In FIG. 19, a virtual piece battle formation of the first account includes a virtual piece A, a virtual piece C, and a virtual piece D. The virtual piece battle formation of the second account includes a virtual piece B and a virtual piece E. A part 19-1 refers to a display effect of the virtual piece battle formation of the first account in a first sub-area 1901 in a first board area 1910 before a terminal makes a response to the formation display operation on the second account. A part 19-2 refers to a display effect of the virtual piece battle formation of the first account in the first sub-area 1901 in the first board area 1910 and a display effect of the virtual piece battle formation of the second account in a second sub-area 1902 in the first board area 1910 after the terminal makes a response to the formation display operation on the second account. A part 19-3 refers to a display effect of the virtual piece battle formation of the second account in a second board area 1920.

That is, display effects of the virtual piece battle formation of the first account in the first sub-area 1901 in the first board area 1910 before and after a response is made to the formation display operation on the second account. After a response is made to the formation display operation on the second account, mirrored display content of the virtual piece battle formation of the second account in the second board area of the second account is projected and displayed in the first board area 1910. A mirroring manner of the mirrored display content is performing central mirroring around a center point of a board area (the first board area 1910 or the second board area 1920) as a reference.

The virtual piece battle formation of the second account can be directly displayed in the first board area of the first account by performing the formation display operation on the second account, and a player does not need to repeatedly switch perspectives of accounts to observe a mirrored screen of the virtual piece battle formation, thereby reducing load on running of a computer and freezing of game screens. The player of the first account can directly observe the virtual piece battle formation of the second account from a same perspective by directly simulating pictures in a battle phase, and adjust the virtual piece battle formation of the first account in a targeted manner, thereby improving human-computer interaction efficiency when the player plans the virtual piece battle formation.

In some aspects, content displayed in the first board area and the second board area has a full mirror/partial mirror relationship based on whether the first account and the second account simultaneously request to display the virtual piece battle formations of the opponents.

For example, the first account and the second account are matched to an n^{th} round for a virtual battle. After detecting the formation display operation on the second account, a terminal where the first account is logged in displays the virtual piece battle formation of the first account and the virtual piece battle formation of the second account in the first board area. After detecting a formation display operation on the first account, a terminal where the second account is logged in displays the virtual piece battle formation of the first account and the virtual piece battle formation of the second account in the second board area. In this case, there is a complete mirror relationship between content displayed in the first board area and content displayed in the second board area. If the terminal where the second account is logged in does not detect the formation display operation on the first account, only the virtual piece battle formation of the second account is displayed in the second board area. In this case, the virtual piece battle formation of the second account displayed in the second board area and the virtual piece battle formation of the second account displayed in the second board area are mirrored. In other words, there is a partial mirror relationship between the content displayed in the first board area and the content displayed in the second board area.

In some aspects, types of the second account include but are not limited to the following types:
(1). An account matched to a same virtual battle as the first account. In other words, the first account and the second account perform a virtual battle in an nth round of a game. (2). Any account having a hostile relationship with the first account. For example, eight player accounts are matched into a same game competition. The same competition includes four battlefields, and two player accounts matched to the same battlefield perform a virtual battle. If the eight player accounts include the first account and seven other accounts having a hostile relationship with the first account, the second account is any one of the seven other accounts. (3). An account having a friend relationship with the first account. For example, the second account is performing a virtual match with another account. The first account may provide a battle suggestion to a player to which the second account belongs by observing the virtual piece battle formation of the second account, to assist the player to which the second account belongs to achieve victory. (4). An account marked by the first account. For example, if the second account ranks top ten in all player accounts in the game, the first account may mark the second account, to observe the virtual piece battle formation of the second account for learning.

In some aspects, an example in which the first account and the second account have a hostile relationship and are matched to a same battlefield is used for description. A formation display identifier of the second account is displayed in response to the first account and the second account being matched to form a battle relationship. The virtual piece battle formation of the second account is displayed in the first board area in response to a trigger operation on the formation display identifier. For example, the first account and the second account are matched to form a battle relationship in the n^{th} round of virtual battle, and the formation display identifier of the second account is displayed. During different rounds of virtual battles, the first account and different accounts are matched for battles, and exits the virtual battle when the first account is defeated. In addition to the first board area, a virtual match interface of the first account further includes a formation display identifier corresponding to another account. The formation display identifier is configured for enabling a virtual piece battle formation of another account to be displayed in the first board area of the first account without switching perspectives.

In some aspects, the formation display identifier of the second account is used as an example for description. Types of the formation display identifier include but are not limited to: (1) a profile picture identifier of the second account, for example, a static image or an animated image customized and uploaded by the player to which the second account belongs, or an identifier automatically generated for the second account by a game system; and (2) a formation display control corresponding to the second account.

The virtual piece battle formation of the second account is displayed by displaying the formation display identifier and detecting the trigger operation on the formation display identifier, so that the player can be prompted and guided to view the virtual piece battle formation of the second account in a conspicuous manner, thereby improving human-computer interaction efficiency.

Display manners of the formation display identifiers include but are not limited to: (1) a regular display manner: during a virtual battle process (including a battle preparation phase and a battle phase), the identifier is regularly displayed in the virtual match interface; and (2) a condition-triggered display manner: when an account meets a preset condition, a formation display identifier corresponding to the account is displayed in the virtual match interface.

Displaying the formation display identifier in a regular manner can continuously prompt the player, and provide free choices for the player to view virtual piece battle formations of different accounts. The player can observe a virtual piece battle formation of an account that performs a battle in a next round, to adjust the virtual piece battle formation of the player's own account, thereby improving a win rate, and can also observe a virtual piece battle formation of another account for inspiration or learning, thereby improving the sense of participation and experience of the player in the game, assisting the player in grasping and learning the gameplay of an Auto Chess game as soon as possible, reducing a time taken to plan the battle formation of virtual pieces, and improving human-computer interaction efficiency. Displaying the formation display identifier in a condition-triggered display manner can enhance fun for the player in a game process and reduce load on running of a computer device. Displaying the formation display identifier when a condition is met can reduce a duration for which the identifier information occupies the picture, thereby reducing picture blocking to some extent, relieving a problem of crowded picture display content, and reducing consumption of a computer when the computer loads image resources.

The foregoing condition-triggered display manner is described using an example. For example, when an i^{th} round of virtual battle ends, the game system predicts a match account of each non-eliminated account in an (i+1)^{th} round of virtual battle, and for an account matched to a same round of match, a formation display identifier of the match account is displayed in a virtual match interface corresponding to the account. i is a positive integer.

Taking the first account as an example, after the first round of battle ends, the first account is not eliminated. The system predicts that the first account performs a virtual battle against the second account in the second round, displays the formation display identifier corresponding to the second account in the virtual match interface of the first account in a battle preparation phase of the second round, and displays the virtual piece battle formation of the second account in the first board area of the first account if the formation display identifier is triggered. Similarly, in the battle preparation phase of the second round, the formation display identifier corresponding to the first account is also displayed in a virtual match interface of the second account, and if the formation display identifier is triggered, the virtual piece battle formation of the first account is displayed in the second board area of the second account.

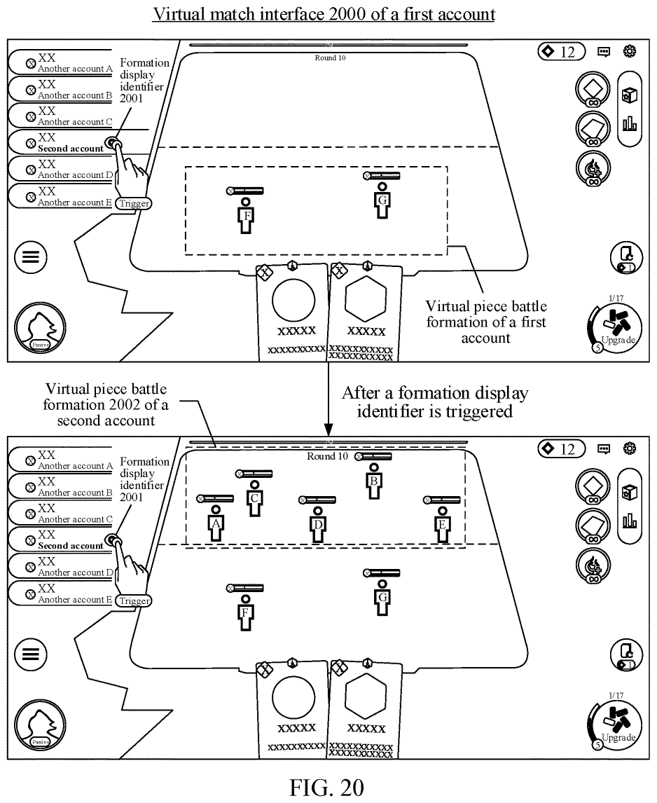

For example, FIG. 20 is a schematic diagram of a process of displaying a virtual piece battle formation of a second account through a trigger operation. In a battle preparation phase, a virtual match interface 2000 of a first account includes a formation display identifier 2001 corresponding to a second account. After the formation display identifier 2001 is triggered, a virtual piece battle formation 2002 of the second account is displayed.

The formation display operation on the second account includes but is not limited to the foregoing manner of triggering the formation display identifier corresponding to the second account, and in some aspects, may be alternatively implemented in another manner. For example, the virtual match interface includes formation display areas that respectively correspond to other accounts, a swipe operation on a formation display area of the second account is received, and the virtual piece battle formation of the second account is displayed in the first board area. This is not limited in this aspect.

Operation 1630: Update the virtual piece battle formation of the second account in the first board area in response to a change in a virtual piece battle formation of the second account in the second board area.

The virtual piece battle formation of the second account is displayed in the first board area. In other words, the content displayed in the second board area of the second account and a change process are directly displayed in the first board area from a mirrored perspective. The player corresponding to the first account may observe, in real time, a process in which the player corresponding to the second account adjusts the virtual piece battle formation, and the virtual piece battle formation of the first account is correspondingly updated.

In some aspects, to improve fairness of the game, a display condition of the virtual piece battle formation may be set. For example, when the formation display operation on the second account is detected, the virtual piece battle formation of the first account may be displayed in the second board area at the same time when the virtual piece battle formation of the second account is displayed in the first board area.

In some aspects, to improve fairness of the game, there is a duration threshold for a period of viewing the virtual piece battle formation of the match account by a player to which each account belongs. When the duration threshold is exceeded, a change process of displaying the virtual piece battle formation of the match account in the board area of the player is canceled, so that the player finally adjusts the virtual piece battle formation, to avoid that a game result is revealed in advance because of excessive information transparency, thereby ensuring experience of the player.

In some aspects, display of the virtual piece battle formation of the second account is frozen in response to a remaining phase duration of the battle preparation phase being less than or equal to a duration threshold in the battle preparation phase of the n^{th} round of virtual battle. The freezing display of the virtual piece battle formation of the second account is keeping the currently displayed virtual piece battle formation of the second account unchanged. Even if the virtual piece battle formation of the second account in the second board area changes, the virtual piece battle formation of the second account displayed in the first board area no longer changes. In other words, the virtual piece battle formation of the second account displayed in the first board area is no longer synchronously updated based on the change in the virtual piece battle formation of the second account in the second board area.

For example, a total duration of the battle preparation phase is 2 minutes, and the duration threshold is 10 seconds. When the remaining phase duration of the battle preparation phase is only 10 seconds, the picture of the virtual piece battle formation of the second account at a current moment is frozen. In this case, if the second account continues to change the virtual piece battle formation, the change process of the virtual piece battle formation of the second account is no longer displayed in the first board area. When the battle preparation phase ends, a battle phase is entered. In this case, display of the virtual piece battle formation of the second account is updated again, and the virtual pieces of the first account and the virtual pieces of the second account automatically battle against each other.

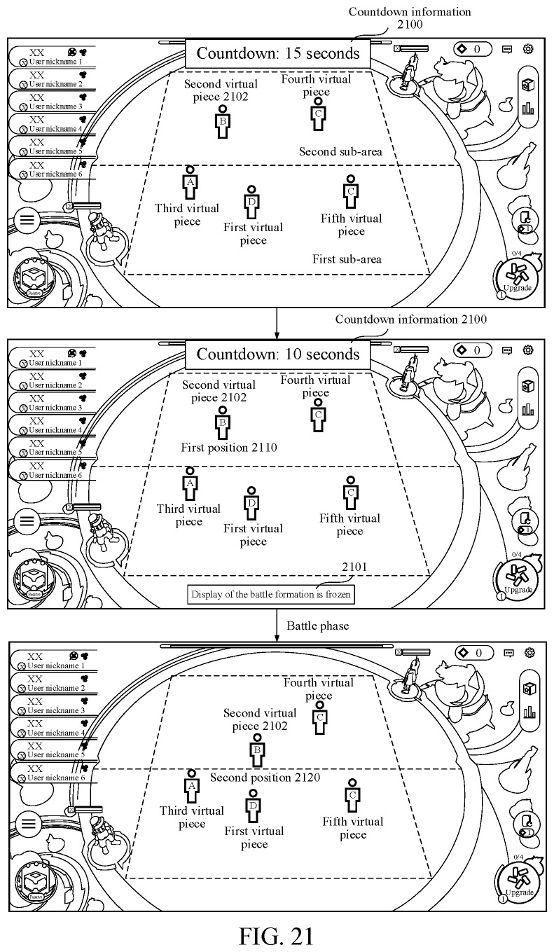

For example, FIG. 21 is a schematic diagram of freezing display of a virtual piece battle formation of a second account. Countdown information 2100 of the remaining phase duration is displayed in the virtual match interface. When the countdown information 2100 is equal to the duration threshold (10 seconds), a prompt text 2101 “Display of the battle formation is frozen” may be displayed. Descriptions are provided by using an example in which the second account continues to adjust the virtual piece battle formation of the second account after the display of the virtual piece battle formation is frozen. The second account deploys a second virtual piece 2102, a position of which during frozen display is a first position 2110, and a position of which in the battle phase is a second position 2120.

In some aspects, display of the virtual piece battle formation of the second account is canceled in response to a remaining phase duration of the battle preparation phase being less than or equal to a duration threshold in the battle preparation phase of the n^{th} round of virtual battle.

For example, a total duration of the battle preparation phase is 2 minutes, and the duration threshold is 10 seconds. When the remaining phase duration of the battle preparation phase is only 10 seconds, display of the virtual piece battle formation of the second account is canceled. In this case, if the second account continues to change the virtual piece battle formation, the virtual piece battle formation of the second account and the change process thereof is no longer displayed in the first board area. When the battle preparation phase ends, a battle phase is entered. In this case, the virtual piece battle formation of the second account is displayed again, and the virtual pieces of the first account and the virtual pieces of the second account automatically battle against each other.

Freezing or canceling display of the virtual piece battle formation within the duration threshold can reduce operation pressure and load of the player when the player continuously adjusts the virtual piece battle formation at a high frequency. In addition, a picture when the virtual piece battle formation changes does not need to be loaded in real time within the duration threshold, thereby saving calculation resources.

In some aspects, after display of the virtual piece battle formation of the second account is frozen or canceled, if the second account adjusts the virtual piece battle formation, the terminal correspondingly displays a change prompt animation to prompt the player of the first account. The change prompt animation does not directly show how the virtual piece battle formation of the second account changes. In some aspects, in response to the battle preparation phase being not finished and the virtual piece battle formation of the second account in the second board area being changed, displaying a change prompt animation without changing the virtual piece battle formation of the second account in the first board area, the change prompt animation indicating that the virtual piece battle formation of the second account is changed.

In some aspects, the first board area includes a first sub-area and a second sub-area; and the first sub-area is configured for displaying the virtual pieces deployed by the first account, and the second sub-area is configured for displaying virtual pieces deployed by another account. After observing the virtual piece battle formation of the second account through the formation display operation, the player may further use a swipe operation to switch content displayed in the second sub-area to a virtual piece battle formation of another account. In some aspects, a virtual piece battle formation of a third account is displayed in the second sub-area in response to a swipe operation on the second sub-area, the virtual piece battle formation of the third account being a battle formation of virtual pieces deployed by the third account in a third board area, and the third board area being an area displayed in a virtual match interface of the third account. In some aspects, the virtual piece battle formation of the third account is displayed in the second sub-area in response to a swipe operation on an account list in the virtual match interface. The account list includes a plurality of accounts, and the plurality of accounts include the second account and the third account.

The third account may be any player account different from the second account and the first account. This is not limited in this aspect. In the manner of switching display content through swiping, the player can view virtual piece battle formations of the plurality of accounts more conveniently, thereby improving human-computer interaction efficiency.

In some aspects, to enhance fun for the player in a game process and avoid a problem that a game result is revealed in advance because of excessive transparency of the virtual piece battle formation, accounts against which the first account performs a virtual battle in a next round may be predicted, and virtual piece battle formations corresponding to a plurality of predicted accounts are displayed. Alternatively, virtual piece battle formations of accounts for battling in a next round are partially displayed. This can ensure that a player is sufficiently prompted in a battle process, and can preserve the suspense of a battle result. In some aspects, virtual piece battle formations of two candidate accounts are displayed in the first board area in response to a formation display operation on the two candidate accounts in the battle preparation phase of the n^{th} round of virtual battle, the two candidate accounts including a target account engaging in a virtual battle against the first account in the n^{th} round of virtual battle. In some aspects, the virtual piece battle formation of the second account includes a plurality of virtual pieces, and at least one virtual piece of the plurality of virtual pieces is hidden when the virtual piece battle formation of the second account is displayed; or a preset virtual element in place of at least one virtual piece of the plurality of virtual pieces is displayed when the virtual piece battle formation of the second account is displayed. In other words, when the virtual piece battle formation of the second account is displayed, some of the plurality of virtual pieces are displayed, and the remaining virtual pieces are replaced with preset virtual elements.

Forms of the preset virtual element include but are not limited to: (1) a contour virtual element, for example, a contour of a virtual piece instead of a specific shape being displayed at the position; (2) a virtual element generated by a system, for example, a two-dimensional/three-dimensional virtual element; (3) a virtual element customized by the player of the second account, for example, a player profile picture, or a player name; and (4) an effect virtual element, for example, a virtual piece at the position being blurred. This is not limited in this aspect.

In summary, in the method provided in this disclosure, the virtual match interface of the first account includes the first board area of the first account, and the first board area includes the virtual pieces deployed by the first account. In response to the formation display operation on the second account, the virtual piece battle formation of the second account can be intuitively displayed in the first board area of the first account. Therefore, virtual piece battle formations of different accounts can be directly observed without repeatedly switching perspectives, thereby simplifying operations of viewing the virtual piece battle formations, and improving human-computer interaction efficiency. In addition, because game screens do not need to be repeatedly loaded, calculation resources are saved, freezing of game screens is reduced, and load on a running process of a computer device is reduced. In addition, compared with the related technology in which a player switches to another player's perspective to obtain piece formation information from a mirrored perspective and then switches back to the player's own perspective, because the method in this aspect of this disclosure can intuitively display a virtual piece battle formation of an opposing player in the first board area of the player, an information reach rate of piece formation information is improved, which is beneficial to reducing load of memorizing and mirror-adjusting the piece formation information by the player, thereby improving efficiency and accuracy of grasping the piece formation information by the player.

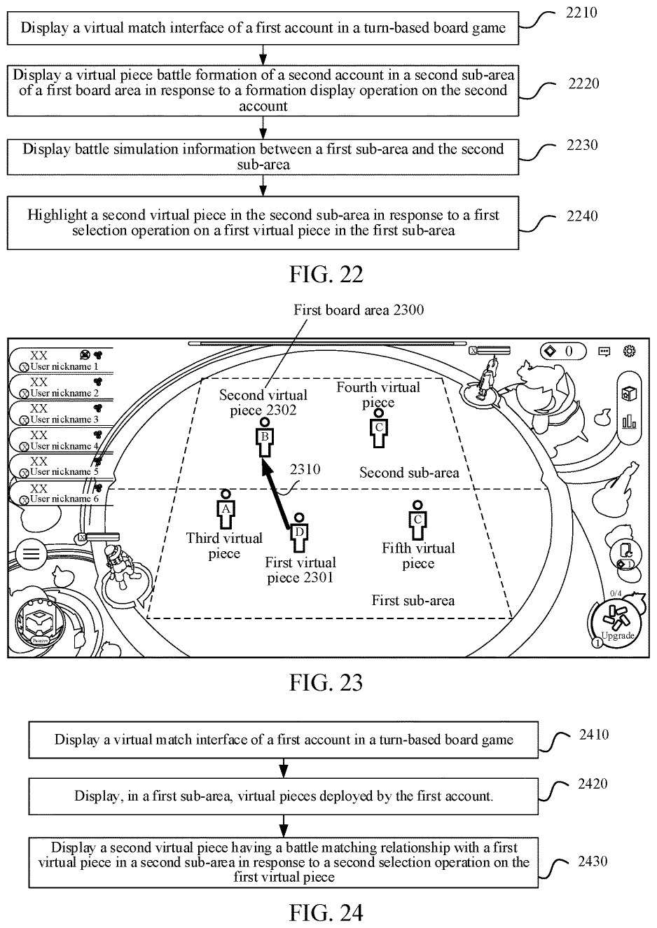

In some aspects, to better assist a player in planning a battle formation of virtual pieces to enable the player to obtain more information that is beneficial to a virtual battle, when a formation display operation on another account is detected, in addition to a virtual piece battle formation of the another account, some other prompt information may be displayed based on the virtual piece battle formation and a counter relationship between virtual pieces. FIG. 22 is a flowchart of a method for displaying a virtual piece battle formation according to another aspect of this disclosure. The method includes the following operations:
Operation 2210: Display a virtual match interface of a first account in a turn-based board game.

The virtual match interface includes a hand area and a first board area, at least one card is displayed in the hand area, the card is configured for deploying a virtual piece in the first board area, and the virtual pieces in the first board area are configured for participating in a turn-based virtual battle based on a battle formation. The first board area includes a first sub-area and a second sub-area; and the first sub-area is configured for displaying the virtual pieces deployed by the first account, and the second sub-area is configured for displaying virtual pieces deployed by another account.

Operation 2220: Display a virtual piece battle formation of a second account in the second sub-area of the first board area in response to a formation display operation on the second account.

The virtual piece battle formation of the second account is a battle formation of virtual pieces deployed by the second account in a second board area, and the second board area is an area displayed in a virtual match interface of the second account. The virtual piece battle formation of the second account is displayed in the second sub-area from a mirrored perspective of the second board area. The another account includes types of all accounts different from the first account, for example, an account having a hostile relationship with the first account, matched to a same round of battle as the first account, having a friend relationship with the first account, or marked by the first account.

Operation 2230: Display battle simulation information between the first sub-area and the second sub-area.

The battle simulation information is configured for representing a counter relationship between the virtual pieces in the first sub-area and the virtual pieces in the second sub-area in a battle formation. The counter relationship indicates attributes, combat powers, and win rates during a battle of different virtual pieces. For example, a counter relationship between a virtual piece A and a virtual piece B is that when a distance between the virtual piece A and the virtual piece B reaches a first distance threshold, the virtual piece A may initiate a remote attack to the virtual piece B.

In some aspects, if there is a counter relationship between virtual pieces, an attack capability of a countered virtual piece is reduced during a virtual battle, or an attack capability of a countering virtual piece is enhanced during a virtual battle. For example, a piece attribute of the virtual piece A counters a piece attribute of the virtual piece B, that is, when the virtual piece A and the virtual piece B battle against each other, if piece levels of the virtual piece A and the virtual piece B are the same, a win rate of the virtual piece A is greater than a win rate of the virtual piece B.

In some aspects, the first sub-area includes a first virtual piece, the second sub-area includes a second virtual piece, a battle matching relationship exists between the first virtual piece and the second virtual piece, and the battle simulation information includes a counter relationship indication element between the first virtual piece and the second virtual piece. In an Auto Chess game, virtual pieces automatically battle against each other, and the battle matching relationship indicates a one-to-one/many-to-one/many-to-many battle relationship in which virtual pieces are automatically matched in a battle phase. For example, the first account deploys the first virtual piece and a third virtual piece, the second account deploys the second virtual piece and a fourth virtual piece, there is a battle matching relationship between the first virtual piece and the second virtual piece, and there is a battle matching relationship between the third virtual piece and the fourth virtual piece. In this case, in the battle phase, the first virtual piece and the second virtual piece automatically battle against each other, and the third virtual piece and the fourth virtual piece automatically battle against each other. If a virtual piece wins or is eliminated, the winning virtual piece may automatically join friendly virtual pieces to battle together against enemy virtual pieces. For example, the first virtual piece battles against the second virtual piece, the first virtual piece wins, and the second virtual piece is eliminated. At this time, if the third virtual piece and the fourth virtual piece are still battling, the first virtual piece may join the third virtual piece to battle together against the fourth virtual piece. Displaying the battle simulation information between sub-areas in which different accounts deploy virtual pieces assists a player in obtaining favorable information in time and improving a win rate of the player in game. Compared with observation and summarization by the player themselves, accuracy of an obtaining result of piece battle information by the player can be improved, and a time consumed to plan a battle formation of virtual pieces can be reduced, thereby improving human-computer interaction efficiency. The diversity and richness of image content are improved.

In some aspects, the counter relationship indication element includes but is not limited to the following several representation forms. (1). The counter relationship indication element is represented as an arrow element, the tail of the arrow represents a countering virtual piece, and the head of the arrow represents a countered virtual piece. For example, if the first virtual piece counters the second virtual piece, the arrow element points from the first virtual piece to the second virtual piece. (2). The counter relationship indication element is represented as a color element, and a pair of virtual pieces having a counter relationship are indicated using a same color but different brightness. For example, if the first virtual piece counters the second virtual piece, the contours of the first virtual piece and the second virtual piece are displayed in red, but the brightness of the first virtual piece is greater than the brightness of the second virtual piece. (3). The counter relationship indication element is represented as a text element, and is indicated by using texts “Countering side” and “Countered side”. For example, if the first virtual piece counters the second virtual piece: text content “Countering side: Second virtual piece” is displayed following the first virtual piece, and the text content indicates that the first virtual piece counters the second virtual piece; and text content “Countered side: First virtual piece” is displayed following the second virtual piece, and the text content indicates that the second virtual piece is countered by the first virtual piece. (4). The counter relationship indication element is represented as a connection line element, and virtual pieces having a counter relationship are connected by a connection line. The width of the connection line decreases from the countering virtual piece to the countered virtual piece. For example, if the first virtual piece counters the second virtual piece, the first virtual piece is connected to the second virtual piece by a solid/dashed connection line, and a portion of the connection line closer to the first virtual piece is wider.

For example, descriptions are provided using an example in which the counter relationship indication element is represented as an arrow element. FIG. 23 is a schematic diagram of displaying a counter relationship indication element between a first virtual piece and a second virtual piece. A first virtual piece 2301 belongs to a first account, and a second virtual piece 2302 belongs to a second account. A first board area 2300 further includes other virtual pieces: a third virtual piece and a fifth virtual piece that belonging to the first account, and a fourth virtual piece belonging to the second account. The first virtual piece 2301, the third virtual piece, and the fifth virtual piece are displayed in a first sub-area of the first board area 2300. The second virtual piece 2302 and the fourth virtual piece are displayed in a second sub-area of the first board area 2300. There is a counter relationship between the first virtual piece 2301 and the second virtual piece 2302, and the first virtual piece 2301 counters the second virtual piece 2302. A counter relationship indication element 2310 is displayed, represented as an arrow element. A direction of the arrow element is from a countering side (the first virtual piece 2301) to a countered side (the second virtual piece 2302).

The battle simulation information may further include an indication element of another type in addition to the counter relationship indication element between the first virtual piece and the second virtual piece. For example, for virtual pieces belonging to a same faction, if there is a carrying relationship between at least two virtual pieces, a carrying relationship indication element between the at least two virtual pieces is displayed. For example, the first virtual piece and the third virtual piece belong to the same faction as the first account. In a battle preparation phase, the first virtual piece and the third virtual piece are both displayed in the first sub-area, and there is a carrying relationship between the first virtual piece and the third virtual piece. The first virtual piece may carry the third virtual piece for a virtual battle. In a process in which the first virtual piece battles against another virtual piece (for example, the second virtual piece), the third virtual piece can take an attack from the second virtual piece on behalf of the first virtual piece, and the carrying relationship with the first virtual piece is automatically released when a damage limit of the third virtual piece is reached. When there is the carrying relationship between the first virtual piece and the third virtual piece, the carrying relationship indication element is displayed as a prompt to prompt the player to place the first virtual piece and the third virtual piece at adjacent positions. For example, a distance between the first virtual piece and the third virtual piece is less than a carrying relationship binding threshold, so that the carrying relationship is successfully established between the first virtual piece and the third virtual piece.

A representation form of the carrying relationship indication element includes but is not limited to the foregoing arrow element, color element, text element, and connection line element. However, the carrying relationship indication element is different from the counter relationship indication element. In other words, the battle simulation information may include various types of indication elements, and each indication element has a different representation form, to facilitate distinction by the player.

Operation 2240: Highlight the second virtual piece in the second sub-area in response to a first selection operation on the first virtual piece in the first sub-area.

In some aspects, because the virtual pieces are different in shape and occupy particular areas in the screen, when many virtual pieces are arranged in the first board area, a problem that the virtual pieces have partially overlapping positions and block each other may occur. If the player cannot directly find, based on features such as shape features and attributes of virtual pieces, a virtual piece having a matching relationship corresponding to the virtual piece, the player may receive a selection operation on the virtual piece, to brighten the virtual piece having a matching relationship with the virtual piece. The manner of highlighting a virtual piece having a battle matching relationship can assist a player in quickly locating a target and grasping gameplay, to adaptively adjust a battle formation of virtual pieces, thereby improving human-computer interaction efficiency.

For example, the first sub-area includes a first virtual piece, the second sub-area includes a second virtual piece, a battle matching relationship exists between the first virtual piece and the second virtual piece, and the first virtual piece counters the second virtual piece. The second virtual piece having the battle matching relationship with the first virtual piece is highlighted in the second sub-area in response to the first selection operation on the first virtual piece. The highlighting may include brightening, zooming in, or the like. For example, the brightening a second virtual piece means that the brightness of the second virtual piece is different from the brightness of other virtual pieces.

In some aspects, to accurately locate the second virtual piece having a battle matching relationship with the first virtual piece, after the first selection operation on the first virtual piece is detected, virtual pieces other than the second virtual piece may be alternatively blurred/blocked/canceled from displaying. This is not limited in this aspect. For example, the first account deploys the first virtual piece and the third virtual piece, and the second account deploys the second virtual piece and the fourth virtual piece. After the first virtual piece is selected, display of the second virtual piece and the first virtual piece is kept, and the third virtual piece and the fourth virtual piece are blurred/blocked/canceled from displaying. Alternatively, after the first virtual piece is selected, display of the first virtual piece is kept, and the first virtual piece, the third virtual piece, and the fourth virtual piece are blurred/blocked/canceled from displaying.

In some aspects, to improve fairness for a player during a game competition, when a formation display operation on another account is detected, a virtual piece battle formation of the another account is not directly fully displayed in the first board area of the first account, and only a virtual piece having a battle matching relationship with a selected virtual piece of virtual pieces deployed by the first account is displayed as prompt information for assisting the player in planning a virtual piece battle formation. FIG. 24 is a flowchart of a method for displaying virtual pieces having a battle matching relationship according to an aspect of this disclosure. The method includes the following operations:

Operation 2410: Display a virtual match interface of a first account in a turn-based board game.

The virtual match interface includes a hand area and a first board area, at least one card is displayed in the hand area, the card is configured for deploying a virtual piece in the first board area, and the virtual pieces in the first board area are configured for participating in a turn-based virtual battle based on a battle formation. The first board area includes a first sub-area and a second sub-area; and the first sub-area is configured for displaying the virtual pieces deployed by the first account, and the second sub-area is configured for displaying virtual pieces deployed by another account.

Operation 2420: Display, in the first sub-area, the virtual pieces deployed by the first account.

The virtual pieces deployed by the first account include the first virtual piece.

Operation 2430: The second virtual piece having the battle matching relationship with the first virtual piece is displayed in the second sub-area in response to the second selection operation on the first virtual piece.

The second virtual piece is a virtual piece deployed in the second board area of the second account, and the second virtual piece is displayed in the second sub-area based on a position of the second virtual piece in the second board area. The second virtual piece is one or more virtual pieces in the virtual piece battle formation of the second account. The virtual piece battle formation of the second account being a formation of pieces deployed by the second account in a second board area, and the second board area is an area displayed in a virtual match interface of the second account.

In some aspects, the virtual pieces deployed by the first account include the first virtual piece and a third virtual piece, and the virtual pieces deployed by the second account include the second virtual piece and a fourth virtual piece. There is a battle matching relationship between the first virtual piece and the second virtual piece. In an Auto Chess game, virtual pieces automatically battle against each other, and the battle matching relationship indicates a one-to-one/many-to-one/many-to-many battle relationship in which virtual pieces are automatically matched in a battle phase. In other words, because there is a battle matching relationship between the first virtual piece and the second virtual piece, in the battle phase, the first virtual piece and the second virtual piece automatically battle against each other. In this case, no matter whether there is a battle matching relationship between the third virtual piece and the fourth virtual piece, the third virtual piece and the fourth virtual piece also automatically battle against each other.

In some aspects, an example in which the battle matching relationship exists between the first virtual piece and the second virtual piece is used for description. Types of the battle matching relationship include, but are not limited to, the following types. (1) There is a counter relationship between the first virtual piece and the second virtual piece. For example, a piece attribute of the first virtual piece counters a piece attribute of the second virtual piece, and the first virtual piece locks the second virtual piece as a target for attack. (2) A distance between the first virtual piece and the second virtual piece in a board area (the first board area of the first account/the second board area of the second account) meets a preset distance requirement. For example, during a battle, the board area (that is, a battle area) includes a plurality of cells having a same size, and the cells are configured for placing virtual pieces for battling in a battle process. If the distance between the first virtual piece and the second virtual piece does not exceed a size of two cells, a preset distance requirement is met, and the first virtual piece and the second virtual piece automatically battle against each other.

In some aspects, the first virtual piece may counter virtual pieces deployed by a plurality of second accounts, or the first virtual piece and the virtual pieces deployed by the plurality of second accounts meet the preset distance requirement. In this case, the counter relationship and the distance may both be used as conditions, and battle matching relationships between the first virtual piece and the virtual pieces deployed by the second accounts are considered. For example, among the virtual pieces deployed by the second account, virtual pieces having a counter relationship with the first virtual piece are used as candidate virtual pieces, and the first virtual piece counters the candidate virtual pieces. A virtual piece of the candidate virtual pieces that is closest to the first virtual piece is determined as the second virtual piece. For example, among the virtual pieces deployed by the second account, virtual pieces whose distance from the first virtual piece meets the preset distance requirement are used as candidate virtual pieces. If a virtual piece forming a counter relationship with the first virtual piece exists in the candidate virtual pieces, the virtual piece is determined as the second virtual piece. If a virtual piece having a counter relationship with the first virtual piece does not exist in the candidate virtual pieces, a virtual piece of the candidate virtual pieces that is closest to the first virtual piece is determined as the second virtual piece.

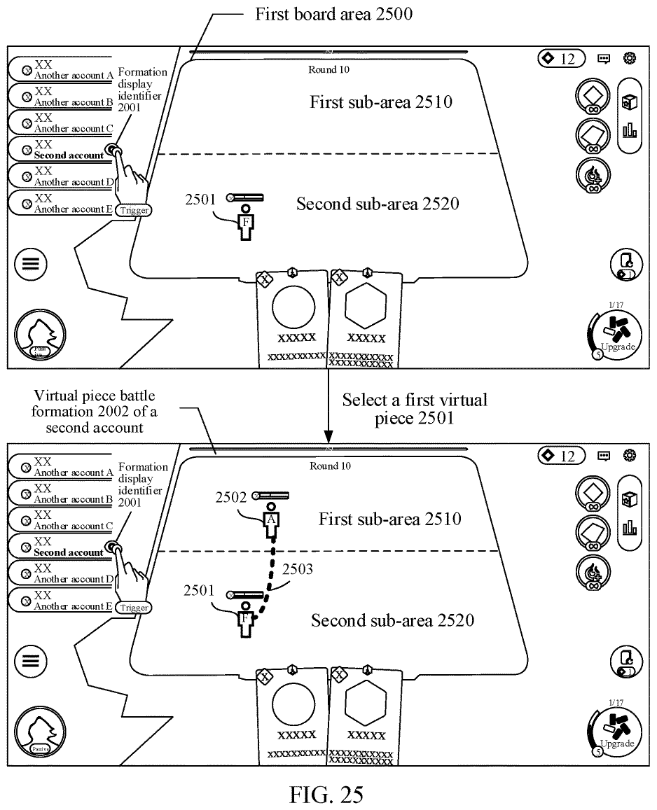

For example, FIG. 25 is a schematic diagram of displaying a second virtual piece in a second sub-area after a first virtual piece is selected. In some aspects, a terminal has detected a formation display operation on a second account. A first board area 2500 includes a first sub-area 2510 and a second sub-area 2520. The first sub-area 2510 includes virtual pieces deployed by a first account (that is, a virtual piece battle formation of the first account). The virtual pieces deployed by the first account include a first virtual piece 2501. The second sub-area 2520 is configured for displaying virtual pieces deployed by the second account (that is, a virtual piece battle formation of the second account) in a battle phase. Before a second selection operation on the first virtual piece 2501 is detected, a virtual piece battle formation of the second account is not displayed in the second sub-area 2520. After the second selection operation on the first virtual piece 2501 is detected, because a battle matching relationship formed between a second virtual piece 2502 and the first virtual piece exists in the virtual pieces deployed by the second account, the second virtual piece 2502 is displayed in the second sub-area 2520. In addition, a battle matching identifier 2503 between the first virtual piece 2501 and the second virtual piece 2502 is displayed. The battle matching identifier 2503 is configured for indicating that the battle matching relationship exists between the first virtual piece 2501 and the second virtual piece 2502, and types of the battle matching identifier 2503 include but are not limited to: (1). a color identifier; (2). a connection line identifier; and (3). a brightened identifier. This aspect is described using an example in which the battle matching identifier 2503 is a connection line identifier.

The virtual piece battle formation of the second account is displayed in the first board area after the terminal detects the formation display operation on the second account. A player to which the first account belongs may correspondingly adjust the virtual piece battle formation of the first account based on the virtual piece battle formation of the second account to achieve victory of the battle.

In some aspects, because the virtual pieces are different in shape and occupy particular areas in the screen, when many virtual pieces are arranged in the first board area, a problem that the virtual pieces have partially overlapping positions and block each other may occur. The player may probably fail to directly capture, based on features such as shape features and attributes of virtual pieces, a virtual piece that plays a significant role in a virtual piece battle formation of an opponent (the significant role means that the virtual piece has a high combat level, a high win rate, and an attribute countering a friendly virtual piece). Alternatively, for a new player who is unfamiliar with an Auto Chess game, even if the new player can view a virtual piece battle formation of an opposing player, the battle formation information usually cannot be efficiently used.

Therefore, more functions and prompt information may be provided for a player on such a basis. Two examples are provided in the following. The first board area includes a first sub-area and a second sub-area; and the first sub-area is configured for displaying the virtual pieces deployed by the first account, and the second sub-area is configured for displaying virtual pieces deployed by another account. The second sub-area includes the second virtual piece.
(1) For example, the virtual piece battle formation of the second account is displayed in the second sub-area of the first board area in response to the formation display operation on the second account. A third virtual piece having a battle gain relationship with the second virtual piece is highlighted in the second sub-area in response to a third selection operation on the second virtual piece.

The third virtual piece is a virtual piece deployed in the second board area of the second account, and the third virtual piece is displayed in the second sub-area based on a position of the third virtual piece in the second board area. The battle gain relationship between virtual pieces means that there are at least two virtual pieces belonging to the same faction, and when a formation manner of these virtual pieces meets a preset gain requirement, the virtual pieces can improve battling powers and match win rates during a virtual battle. After selecting the second virtual piece deployed by the second account, the player of the first account may view the position and the piece type of the third virtual piece having the battle gain relationship with the second virtual piece, and correspondingly adjust the virtual piece battle formation of the first account.

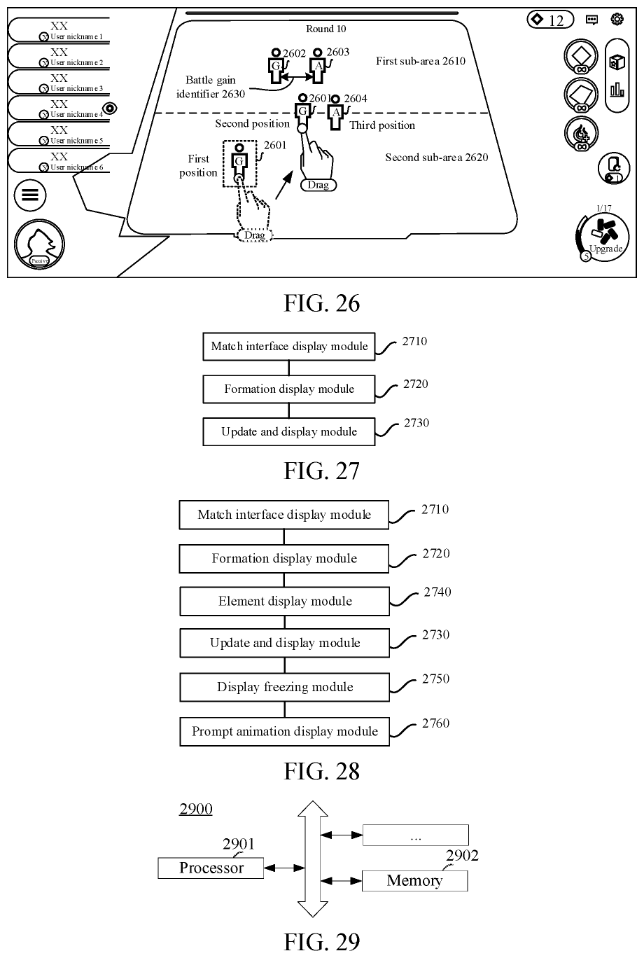

For example, FIG. 26 is a schematic diagram of adjusting a virtual piece battle formation of a first account. A first sub-area 2610 includes a first virtual piece 2601 and a fourth virtual piece 2604. A second sub-area 2620 includes a second virtual piece 2602 and a third virtual piece 2603 that have an battle gain relationship, and a battle gain identifier 2630 exists between the second virtual piece 2602 and the third virtual piece 2603. The first virtual piece 2602 is dragged from a first position to a second position. The second position is adjacent to a third position of the fourth virtual piece 2604 in the first sub-area 2610.
(2) For example, the virtual piece battle formation of the second account is displayed in the second sub-area of the first board area in response to the formation display operation on the second account. A target card in the hand area is highlighted in response to a fourth selection operation on the second virtual piece, the target card being configured for deploying a target virtual piece in the first board area, and an battle matching relationship existing between the target virtual piece and the second virtual piece.

The target card is a piece card that is present in the hand area of the first account but has not been deployed. Brightening the target card can notify a player that a battle matching relationship exists between the target virtual piece corresponding to the target card and the second virtual piece. If the target virtual piece is deployed in the first board area, in a battle phase, the target virtual piece and the second virtual piece automatically battle against each other.

The foregoing two examples can assist a player in capturing key information in time and use obtained information about a virtual piece battle formation more efficiently, thereby improving experience of the player and human-computer interaction efficiency.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 27 is a structural block diagram of an apparatus for displaying a virtual piece battle formation according to an aspect of this disclosure. As shown in FIG. 27, the apparatus includes: a match interface display module 2710, configured to display a virtual match interface of a first account in a turn-based board game, the virtual match interface including a first board area, the first board area including virtual pieces deployed by the first account, and the virtual pieces in the first board area being configured for participating in a turn-based virtual battle based on a battle formation; a formation display module 2720, configured to display a virtual piece battle formation of a second account in the first board area in response to a formation display operation on the second account, the virtual piece battle formation of the second account being a battle formation of virtual pieces deployed by the second account in a second board area, and the second board area being an area displayed in a virtual match interface of the second account; and an update and display module 2730, configured to update the virtual piece battle formation of the second account in the first board area in response to a change in a virtual piece battle formation of the second account in the second board area.

In some aspects, the virtual match interface further includes a hand area, at least one card is displayed in the hand area, and the card is configured for deploying a virtual piece in the first board area.

In some aspects, the formation display module 2720 is configured to display the virtual piece battle formation of the second account in the first board area in response to the formation display operation on the second account in a battle preparation phase of an n^{th} round of virtual battle, n being a positive integer.

In some aspects, the first board area includes a first sub-area and a second sub-area; and the first sub-area is configured for displaying the virtual pieces deployed by the first account, and the second sub-area is configured for displaying virtual pieces deployed by another account. The formation display module 2720 is further configured to display the virtual piece battle formation of the second account in the second sub-area of the first board area in response to the formation display operation on the second account, the virtual piece battle formation of the second account being displayed in the second sub-area from a mirrored perspective of the second board area.

In some aspects, as shown in FIG. 28, the apparatus further includes: an element display module 2740, configured to display battle simulation information between the first sub-area and the second sub-area, the battle simulation information being configured for representing a counter relationship between the virtual pieces in the first sub-area and the virtual pieces in the second sub-area in a battle formation.

In some aspects, the first sub-area includes a first virtual piece, the second sub-area includes a second virtual piece, a battle matching relationship exists between the first virtual piece and the second virtual piece, and the battle simulation information includes a counter relationship indication element between the first virtual piece and the second virtual piece.

In some aspects, the element display module 2740 is further configured to highlight the second virtual piece in the second sub-area in response to a first selection operation on the first virtual piece in the first sub-area.

In some aspects, the formation display module 2720 is further configured to: display a formation display identifier of the second account in response to the first account and the second account being matched to form a battle relationship in the n^{th} round of virtual battle; and display the virtual piece battle formation of the second account in the first board area in response to a trigger operation on the formation display identifier.

In some aspects, the first board area includes a first sub-area and a second sub-area; and the first sub-area is configured for displaying the virtual pieces deployed by the first account, and the second sub-area is configured for displaying virtual pieces deployed by another account. The formation display module 2720 is further configured to: display, in the first sub-area, the virtual pieces deployed by the first account, the virtual pieces deployed by the first account including the first virtual piece; and display, in the second sub-area in response to a second selection operation on the first virtual piece, the second virtual piece having the battle matching relationship with the first virtual piece, the second virtual piece being a virtual piece deployed in the second board area of the second account, and the second virtual piece being displayed in the second sub-area based on a position of the second virtual piece in the second board area.

In some aspects, the apparatus further includes: a freezing display module 2750, configured to display of the virtual piece battle formation of the second account in response to a remaining phase duration of the battle preparation phase being less than or equal to a duration threshold in the battle preparation phase of the n^{th} round of virtual battle; or cancel display of the virtual piece battle formation of the second account in response to a remaining phase duration of the battle preparation phase being less than or equal to a duration threshold in the battle preparation phase of the n^{th} round of virtual battle.

In some aspects, the apparatus further includes: a prompt animation display module 2760, configured to display, in response to the battle preparation phase being not finished and the virtual piece battle formation of the second account in the second board area being changed, a change prompt animation without changing the virtual piece battle formation, the change prompt animation indicating that the virtual piece battle formation of the second account is changed.

In some aspects, the first board area includes a first sub-area and a second sub-area; and the first sub-area is configured for displaying the virtual pieces deployed by the first account, the second sub-area is configured for displaying virtual pieces deployed by another account, and the second sub-area includes a second virtual piece. The element display module 2740 is further configured to highlight, in the second sub-area in response to a third selection operation on the second virtual piece, a third virtual piece having a battle gain relationship with the second virtual piece, the third virtual piece being a virtual piece deployed in the second board area of the second account, and the third virtual piece being displayed in the second sub-area based on a position of the third virtual piece in the second board area.

In some aspects, the first board area includes a first sub-area and a second sub-area; and the first sub-area is configured for displaying the virtual pieces deployed by the first account, the second sub-area is configured for displaying virtual pieces deployed by another account, and the second sub-area includes a second virtual piece. The element display module 2740 is further configured to highlight a target card in the hand area in response to a fourth selection operation on the second virtual piece, the target card being configured for deploying a target virtual piece in the first board area, and an battle matching relationship existing between the target virtual piece and the second virtual piece.

In some aspects, the first board area includes a first sub-area and a second sub-area; and the first sub-area is configured for displaying the virtual pieces deployed by the first account, and the second sub-area is configured for displaying virtual pieces deployed by another account. The formation display module 2720 is further configured to: display a virtual piece battle formation of a third account in the second sub-area in response to a swipe operation on the second sub-area, the virtual piece battle formation of the third account being a battle formation of virtual pieces deployed by the third account in a third board area, and the third board area being an area displayed in a virtual match interface of the third account; or display the virtual piece battle formation of the third account in the second sub-area in response to a swipe operation on an account list in the virtual match interface, the account list including a plurality of accounts, and the plurality of accounts including the second account and the third account.

In some aspects, the formation display module 2720 is further configured to display virtual piece battle formations of two candidate accounts in the first board area in response to a formation display operation on the two candidate accounts in the battle preparation phase of the n^{th} round of virtual battle, the two candidate accounts including a target account engaging in a virtual battle against the first account in the n^{th} round of virtual battle.

In some aspects, the virtual piece battle formation of the second account includes a plurality of virtual pieces. The formation display module 2720 is further configured to: hide at least one virtual piece of the plurality of virtual pieces when the virtual piece battle formation of the second account is displayed; or display a preset virtual element in place of at least one virtual piece of the plurality of virtual pieces when the virtual piece battle formation of the second account is displayed.

In summary, for the apparatus for displaying a virtual piece battle formation provided in this disclosure, the virtual match interface of the first account includes the first board area of the first account, and the first board area includes the virtual pieces deployed by the first account. In response to the formation display operation on the second account, the virtual piece battle formation of the second account can be intuitively displayed in the first board area of the first account. Therefore, virtual piece battle formations of different accounts can be directly observed without repeatedly switching perspectives, thereby simplifying operations of viewing the virtual piece battle formations, and improving human-computer interaction efficiency. In addition, because game screens do not need to be repeatedly loaded, calculation resources are saved, freezing of game screens is reduced, and load on a running process of a computer device is reduced. In addition, compared with the related technology in which a player switches to another player's perspective to obtain piece formation information from a mirrored perspective and then switches back to the player's own perspective, because the method in this aspect of this disclosure can intuitively display a virtual piece battle formation of an opposing player in the first board area of the player, an information reach rate of piece formation information is improved, which is beneficial to reducing load of memorizing and mirror-adjusting the piece formation information by the player, thereby improving efficiency and accuracy of grasping the piece formation information by the player.

FIG. 29 is a structural block diagram of a computer device 2900 according to an aspect of this disclosure. The computer device 2900 may be a smartphone, a tablet computer, a Moving Picture Experts Group Audio Layer III (MP3) player, a Moving Picture Experts Group Audio Layer IV (MP4) player, a notebook computer, or a desktop computer. The computer device 2900 may also be referred to as other names such as user equipment, a portable terminal, a laptop terminal, or a desktop terminal.

In an aspect, the computer device 2900 includes a processor 2901 (an example of processing circuitry) and a memory 2902. The processor 2901 may include one or more processing cores, for example, a 4-core processor or an 8-core processor. The processor 2901 may be implemented in at least one hardware form of a digital signal processor (DSP), a field-programmable gate array (FPGA), and a programmable logic array (PLA). The memory 2902 may include one or more computer-readable storage media. The computer-readable storage medium may be non-transitory. The memory 2902 may further include a high-speed random access memory and a non-volatile memory, for example, one or more disk storage devices and flash storage devices. In some aspects, the non-transitory computer-readable storage medium in the memory 2902 is configured to store at least one instruction. The at least one instruction is executable by the processor 2901 to implement the method for displaying a virtual piece battle formation provided in the method aspects of this disclosure.

In some aspects, the computer device 2900 further include another component. The structure shown in FIG. 29 does not constitute a limitation on the computer device 2900, which may include more or fewer components than those shown in the figure, or some components may be combined, or a different component deployment may be used.

Aspects of this disclosure further include a computer device, the computer device including a processor (an example of processing circuitry) and a memory, the memory having at least one instruction, at least one program, a code set, or an instruction set stored therein, and the at least one instruction, the at least one program, the code set, or the instruction set being loaded and executed by the processor to implement the method for displaying a virtual piece battle formation in any of the foregoing aspects of this disclosure.

Aspects of this disclosure further include a computer-readable storage medium (e.g., a non-transitory computer-readable storage medium), the storage medium having at least one instruction, at least one program, a code set, or an instruction set stored therein, and the at least one instruction, the at least one program, the code set, or the instruction set being loaded and executed by a processor to implement the method for displaying a virtual piece battle formation in any of the foregoing aspects of this disclosure.

An aspect of this disclosure further provides a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, to enable the computer device to perform the method for displaying a virtual piece battle formation in any of the foregoing aspects.

All or a part of the steps of the aspects may be implemented by hardware or a program instructing relevant hardware. The program may be stored in a computer-readable storage medium. The storage medium may be a read-only memory, a magnetic disk, an optical disc or the like. The foregoing aspects of this disclosure are not intended to limit this disclosure.

The foregoing disclosure includes some aspects of this disclosure which are not intended to limit the scope of this disclosure. Other aspects shall also fall within the scope of this disclosure.

What is claimed is:

1. A method for displaying a virtual piece battle formation, comprising:
displaying, in a first board area of a first virtual match interface of a first user, first virtual pieces that are to participate in a virtual battle with second virtual pieces displayed in a second board area of a second virtual match interface of a second user;
displaying, in the first board area of the first virtual match interface, a first battle formation of the second virtual pieces, the first battle formation indicating a second battle formation of the second virtual pieces in the second board area of the second virtual match interface of the second user; and
updating, in the first board area of the first virtual match interface, the first battle formation in response to a change in the second battle formation.

2. The method according to claim 1, wherein the first virtual match interface includes a hand area in which at least one card is displayed, the at least one card being used to deploy a virtual piece in the first board area.

3. The method according to claim 1, wherein the displaying the first battle formation comprises:
displaying, in the first board area of the first virtual match interface, the first battle formation of the second virtual pieces in a battle preparation phase of the virtual battle.

4. The method according to claim 1, wherein the first board area includes a first sub-area in which the first virtual pieces are displayed and a second sub-area in which the second virtual pieces are displayed, and the displaying the first battle formation comprises:
displaying, in the second sub-area of the first board area, the first battle formation of the second virtual pieces, the first battle formation displayed in the second sub-area being mirrored to the second battle formation displayed in the second board area.

5. The method according to claim 4, further comprising:
displaying battle simulation information in an area between the first sub-area and the second sub-area, the battle simulation information representing a counter relationship between the first virtual pieces in the first sub-area and the second virtual pieces in the second sub-area.

6. The method according to claim 5, wherein the battle simulation information includes a counter relationship indication element between the first virtual pieces and the second virtual pieces.

7. The method according to claim 4, further comprising:
highlighting the second virtual pieces in the second sub-area in response to a first selection operation on the first virtual pieces in the first sub-area.

8. The method according to claim 1, wherein the displaying the first battle formation comprises:
displaying a formation display identifier of the second user in response to the first user and the second user being matched to form a battle relationship; and
displaying, in the first board area of the first virtual match interface, the first battle formation in response to a trigger operation on the formation display identifier.

9. The method according to claim 4, wherein the displaying the first battle formation comprises:
displaying, in the second sub-area of the first board area and in response to a second selection operation on the first virtual pieces, the second virtual pieces based on positions of the second virtual pieces in the second board area.

10. The method according to claim 1, further comprising:
freezing or canceling the display of the first battle formation in response to a remaining duration of a battle preparation phase of the virtual battle being less than or equal to a duration threshold.

11. The method according to claim 10, further comprising:
displaying, in response to the battle preparation phase not being finished and the second battle formation being changed, a change prompt animation indicating that the second battle formation is changed.

12. The method according to claim 4, further comprising:
displaying, in the second sub-area of the first board area and in response to a third selection operation on the second virtual pieces, a third virtual piece that is deployed in the second board area of the second virtual match interface and has a battle gain relationship with the second virtual pieces; and
highlighting the third virtual piece.

13. The method according to claim 2, further comprising:
highlighting a target card in the hand area in response to a fourth selection operation on the second virtual pieces, the target card being used to deploy a target virtual piece in the first board area, and the target virtual piece having an battle matching relationship with the second virtual pieces.

14. The method according to claim 4, further comprising:
displaying, in the second sub-area of the first board area, a third battle formation of fourth virtual pieces in response to a swipe operation on the second sub-area or a user list, the third battle formation indicating a fourth battle formation of the fourth virtual pieces in a third board area of a third virtual match interface of a third user, and the user list including the second user and the third user.

15. The method according to claim 1, further comprising:
displaying, in the first board area of the first virtual match interface, virtual piece battle formations of two candidate users in a battle preparation phase of the virtual battle, the two candidate users including a target user engaging in the virtual battle against the first user.

16. The method according to claim 1, further comprising:
hiding at least one of the second virtual pieces when the first battle formation is displayed; or
displaying a preset virtual element in place of the at least one of the second virtual pieces when the first battle formation is displayed.

17. An apparatus for displaying a virtual piece battle formation, comprising processing circuitry configured to:
display, in a first board area of a first virtual match interface of a first user, first virtual pieces that are to participate in a virtual battle with second virtual pieces displayed in a second board area of a second virtual match interface of a second user;
display, in the first board area of the first virtual match interface, a first battle formation of the second virtual pieces, the first battle formation indicating a second battle formation of the second virtual pieces in the second board area of the second virtual match interface of the second user; and
update, in the first board area of the first virtual match interface, the first battle formation in response to a change in the second battle formation.

18. The apparatus according to claim 17, wherein the first virtual match interface further includes a hand area in which at least one card is displayed, the at least one card being used to deploy a virtual piece in the first board area.

19. A non-transitory computer-readable storage medium storing instructions, which when executed by a processor, cause the processor to implement a method for displaying a virtual piece battle formation, the method comprising:
displaying, in a first board area of a first virtual match interface of a first user, first virtual pieces that are to participate in a virtual battle with second virtual pieces displayed in a second board area of a second virtual match interface of a second user;
displaying, in the first board area of the first virtual match interface, a first battle formation of the second virtual pieces, the first battle formation indicating a second battle formation of the second virtual pieces in the second board area of the second virtual match interface of the second user; and
updating, in the first board area of the first virtual match interface, the first battle formation in response to a change in the second battle formation.

20. The non-transitory computer-readable storage medium according to claim 19, wherein the first virtual match interface further includes a hand area in which at least one card is displayed, the at least one card being used to deploy a virtual piece in the first board area.
